(19) United States
(12) Patent Application Publication
(10) Pub. No.: US 2025/0020770 A1
(43) Pub. Date: Jan. 16, 2025

(54) RADAR APPARATUS AND RADAR SIGNAL PROCESSING METHOD

(71) Applicant: Panasonic Automotive Systems Co., Ltd., Kanagawa (JP)

(72) Inventors: Hidekuni YOMO, Kanagawa (JP); Tomohiro YUI, Kanagawa (JP); Kenta IWASA, Kanagawa (JP); Kouji SUZUKI, Kanagawa (JP); Takaaki KISHIGAMI, Tokyo (JP); Noriaki SAITO, Tokyo (JP); Junji SATO, Tokyo (JP)

(21) Appl. No.: 18/896,628

(22) Filed: Sep. 25, 2024

Related U.S. Application Data
(63) Continuation of application No. PCT/JP2023/002477, filed on Jan. 26, 2023.

(30) Foreign Application Priority Data
Mar. 29, 2022 (JP) 2022-054119

(51) Int. Cl. G01S 7/35; G01S 7/03; G01S 7/40; G01S 13/34

(52) U.S. Cl. CPC G01S 7/352; G01S 7/03; G01S 7/4017; G01S 7/4021; G01S 13/341

(57) ABSTRACT

A radar apparatus includes: a first module; a second module; and a cable that connects the first module to the second module, in which the first module includes: a signal processing circuit that outputs a plurality of beat signals respectively for a plurality of reception antennas, and a control circuit that starts the signal processing circuit in accordance with a start command received from the second module via the cable, and the second module includes: a detection circuit that detects an object based on the plurality of beat signals received from the first module via the cable, and a command circuit that transmits the start command to the first module.

### CROSS REFERENCE TO RELATED APPLICATIONS

This application is entitled and claims the benefit of Japanese Patent Application No. 2022-054119, filed on Mar. 29, 2022, the disclosure of which including the specification, drawings and abstract is incorporated herein by reference in its entirety.

### TECHNICAL FIELD

The present disclosure relates to a radar apparatus and a radar signal processing method.

### BACKGROUND ART

In recent years, radar apparatuses using millimeter waves have gained attention as sensors for ensuring safety, such as collision prevention in vehicles, or for realizing automatic driving. A radar apparatus that uses the millimeter wave band, for example, experiences minimal degradation in detection performance even in surrounding environments with poor visibility, such as snowfall or dense fog.

For example, the radar apparatus is divided into a front-end module and a back-end module, with the front-end module and the back-end module connected by a cable. The front-end module includes, for example, an antenna and a radio processor connected to the antenna, while the back-end module includes, for example, a processing unit that performs object detection processing and a heat dissipation apparatus that radiates heat emitted from the processing unit. By separating the radar apparatus into the front-end module and the back-end module, it is possible to reduce the size of the front-end module and improve the ease of installation of the front-end module, which includes the antenna, on a vehicle.

The radio processor is constituted by, for example, a System On Chip (SoC). To enhance the versatility of the radio processing unit configured by the SoC, the number of antennas to be connected is designed to be fewer than the total number of antennas in the radar apparatus.

For example, the number of antennas connected to the radio processor is set to three for the transmission antennas and four for the reception antennas. A user, such as a designer or manufacturer of a radar apparatus, can design or manufacture a radar apparatus with a small number of antennas or a radar apparatus with a large number of antennas by increasing or decreasing the number of SoCs (radio processors) used in the radar apparatus.

### CITATION LIST

### Patent Literature

### PTL 1

Japanese Unexamined Patent Application Publication (Translation of PCT Application) No. 2017-521669

### PTL 2

U.S. patent Ser. No. 10/641,881

### SUMMARY OF INVENTION

### Technical Problem

In cases where a radar apparatus is separated into a front-end module and a back-end module, the object detection performance may decrease depending on how the functions are divided between the front-end module and the back-end module.

Further, when the radar apparatus is divided into a front-end module and a back-end module, the starting time of the radio processor, which is started based on control from the back-end module, may become longer.

An aspect of a radar apparatus according to the present disclosure contributes to providing a radar apparatus that suppresses a decrease in object detection performance and shortens starting time.

### Solution to Problem

A radar apparatus according to one exemplary embodiment of the present disclosure includes: a first module; a second module; and a cable that connects the first module to the second module, in which the first module includes: a signal processing circuit that outputs a plurality of beat signals respectively for a plurality of reception antennas, and a control circuit that starts the signal processing circuit in accordance with a start command received from the second module via the cable, and the second module includes: a detection circuit that detects an object based on the plurality of beat signals received from the first module via the cable, and a command circuit that transmits the start command to the first module.

A radar signal processing method according to one exemplary embodiment of the present disclosure includes: transmitting a start trigger command from a command circuit of a second module to a control circuit of a first module via a cable connecting the first module to the second module; receiving, by the control circuit of the first module, the start trigger command from the second module; outputting, in response to the start trigger command, a control command from the control circuit of the first module to a signal processing circuit of the first module, the control command being used for starting the signal processing circuit of the first module; outputting, from the signal processing circuit started of the first module to a detection circuit of the second module, a plurality of beat signals respectively for a plurality of reception antennas connected to the signal processing circuit of the first module; and detecting, by the detection circuit of the second module, an object based on the plurality of beat signals received from the first module via the cable.

Note that these general or specific aspects may be realized by a system, an apparatus, a method, an integrated circuit, a computer program, or a recording medium, and may be realized by any combination of a system, an apparatus, a method, an integrated circuit, a computer program, and a recording medium.

### Advantageous Effects of Invention

According to an embodiment of the present disclosure, the radar apparatus can suppress a decrease in the object detection performance and can reduce the starting time.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram showing a block configuration example of a radar apparatus;

FIG. 2 illustrates an exemplary block configuration of a radar circuit (master chip);

FIG. 3 is another block configuration example of the radar apparatus;

FIG. 4 illustrates an example of a block configuration of a radar apparatus according to Embodiment 1;

FIG. 5 is a diagram showing a block configuration example of a radar circuit (slave chip);

FIG. 6 illustrates a block configuration example of a processing unit;

FIG. 7 illustrates an example of beat signal suppression;

FIG. 8 is a diagram illustrating an example of a processing timing of the processing unit;

FIG. 9 illustrates an example of a block configuration of a radar apparatus according to Embodiment 2;

FIG. 10 is a diagram illustrating an example of an operation stop process of the radar circuit (slave chip) and the radar circuit (slave chip) of a controller;

FIG. 11A illustrates an example of a block configuration of a radar apparatus according to Embodiment 3;

FIG. 11B is a diagram illustrating an example of the processing timing of the processing unit according to Embodiment 3;

FIG. 12 illustrates an example of a block configuration of a radar apparatus according to Embodiment 4;

FIG. 13 illustrates an example of a block configuration of a radar apparatus according to Embodiment 5;

FIG. 14 is a block configuration diagram illustrating an example of a processing unit in a radar apparatus according to Embodiment 6;

FIG. 15 illustrates an example of a block configuration of a radar apparatus according to Embodiment 7;

FIG. 16 illustrates an example of a block configuration of a radar apparatus according to Embodiment 8; and

FIG. 17 illustrates an example of a block configuration of a radar apparatus according to Embodiment 9.

### DESCRIPTION OF EMBODIMENTS

Hereinafter, embodiments of the present disclosure will be described in detail with appropriate reference to the drawings. However, any unnecessarily detailed description may be omitted. For example, detailed descriptions of already well-known matters and repeated descriptions for substantially the same configuration may be omitted. This is to avoid the unnecessary redundancy of the following description and to facilitate understanding of those skilled in the art.

It is to be noted that the accompanying drawings and the following description are provided to enable those skilled in the art to fully understand this disclosure, and are not intended to limit the claimed subject.

The present disclosure, for example, relates to a technology for realizing a compact front-end module that includes a plurality of SoCs operating in synchronization with each other. Each of the multiple SoCs is connected to a transmission/reception antenna, and the transmission/reception processing of radar signals is executed.

The radar apparatus of the present disclosure is, for example, mounted on a vehicle. The mounting position is, for example, a bumper, a roof, a side mirror, or a fender. Note that the radar apparatus of the present disclosure is not limited to being mounted on a vehicle and may also be applied to infrastructure such as road lights installed on road shoulders or facilities for monitoring illegal intrusions.

Heretofore, radar apparatuses have been used in relatively simple environments where the number and types of objects included within a detection target region are limited, such as exclusive automobile roads. For this reason, the function of the radar apparatuses was, for example, sufficient to detect the distance to a detection target and the arrival direction of a reception signal in the horizontal direction.

Further, in the related art, the detection target is limited to moving vehicles, and stationary objects such as road installations and parked or stopped vehicles are excluded. This is to avoid control actions such as sudden braking caused by erroneous detection of stationary objects like signs, overpasses, or manholes on the street that do not need to be detected.

As described above, in existing radar apparatuses, the detection targets are limited. Consequently, these radar apparatuses are configured with a relatively small number of antennas, such as three transmission antennas and four reception antennas.

Meanwhile, there is an increasing demand for expanding the detection target region of a radar apparatus to include driving scenes such as urban areas. There is also a demand for a function to detect the arrival direction of a reception signal in the vertical direction in addition to the existing function of detecting the distance to a detection target and the arrival direction of a reception signal in the horizontal direction since environments such as cities are complex and contain a large number of various types of objects.

Further, for example, a stationary object located at a position higher than the position through which a vehicle passes is excluded from the detection target, while a stationary object such as a parked or stopped vehicle, which has a possibility of collision, is included as a detection target.

In order to detect stationary objects, the number of antennas in the radar apparatus is increased in the vertical direction. As described above, regarding the exemplary number of antennas that can be connected to an SoC performing transmission/reception processing of millimeter wave radar signals, the number of transmission antennas is three, and the number of reception antennas is approximately four in the related art taking into consideration the versatility and other factors. For this reason, to increase the number of antennas in the radar apparatus, it is necessary to increase the number of SoCs, for example, to accommodate the additional antennas. Note that an SoC that performs transmission/reception processing of a milliwave radar signal may also be referred to as a Monolithic Microwave IC (MMIC). IC stands for Integrated Circuit.

By synchronizing the operation of multiple SoCs, it is possible to integrally process the signals from antennas connected to each of the multiple SoCs and utilize the signals for detecting the arrival direction of millimeter-wave signals.

Accordingly, one of the plurality of SoCs is designated as a master, and a local signal that forms the basis of a carrier wave generated by the master (for example, a chirp signal) and a frame synchronization signal constituting one unit of radar signal processing, are distributed to the remaining SoCs (slaves).

Additionally, as the number of antennas increases, the radar apparatus may become larger, potentially causing installation constraints in vehicles or similar applications.

Accordingly, the radar apparatus is divided into a front-end module and a back-end module, and these modules are connected to each other using a high-speed transmission cable or similar means.

### <Study 1>

Exemplary radar methods for a radar apparatus include a Frequency Modulated Continuous Wave (FMCW) method and/or a Fast-Chirp method. An SoC that implements these methods branches a part of a frequency-chirped transmission signal and mixes it with a reception signal, which is a reflection wave from an object. Mixing the transmission signal and the reception signal results in a beat signal with a frequency proportional to the distance between the radar apparatus and the object.

In a driving scene in an urban area or the like, reflection waves are generated from various objects. Therefore, in the FMCW method according to the related art, the number of pairing combinations increases, making the object detection process complicated when determining pairings in the up-chirp and down-chirp. For example, in the related art, the Fast-Chirp scheme may be adopted. Further, to achieve high distance resolution detection for objects with high relative velocity, the Fast-Chirp method, which repeatedly transmits a broad-band frequency chirp in short cycles, is useful.

In the case where a wideband frequency chirp is repeatedly transmitted in short cycles, the frequency varies significantly within a short time, causing the frequency of the beat signal corresponding to a reflection wave from a distant object to become relatively high. For this reason, the sampling rate of an analog/digital (A/D) converter that converts an analog beat signal into a digital signal becomes high.

Further, in order to detect both large objects, such as trucks, which have a large reflection sectional area, and small objects, such as pedestrians, which have a small reflection sectional area, the dynamic range of the reception signal is increased. For this reason, the A/D converter that converts an analog beat signal into a digital signal requires a larger bit width.

When the sampling rate and bit width of the A/D converter increase, the transmission speed of a digital signal after A/D conversion becomes faster.

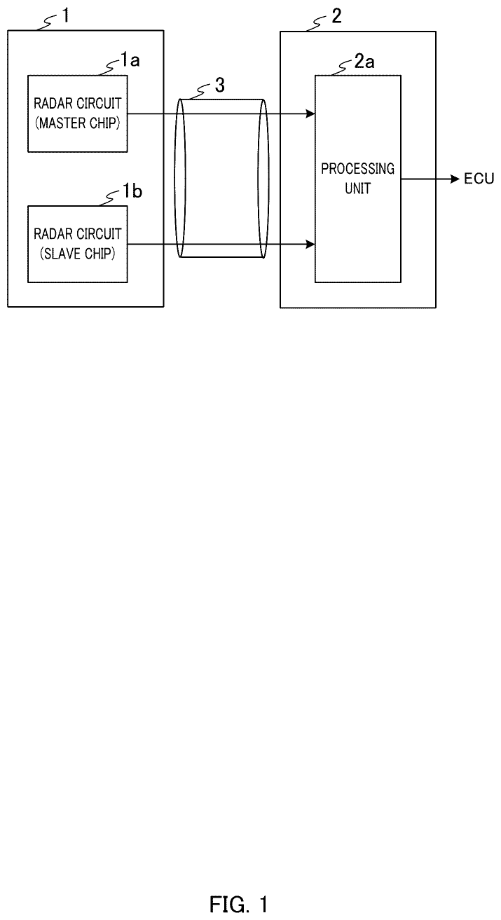

As illustrated in FIG. 1, the radar apparatus includes front-end module 1, back-end module 2, and cable 3. Cable 3 connects front-end module 1 to back-end module 2.

Front-end module 1 includes radar circuit (master chip) 1a and radar circuit (slave chip) 1b. The radar circuit (master chip) is composed of, for example, a single SoC. Radar circuit (slave chip) 1b is composed of, for example, a single SoC. Here, radar circuit (master chip) 1a will be described.

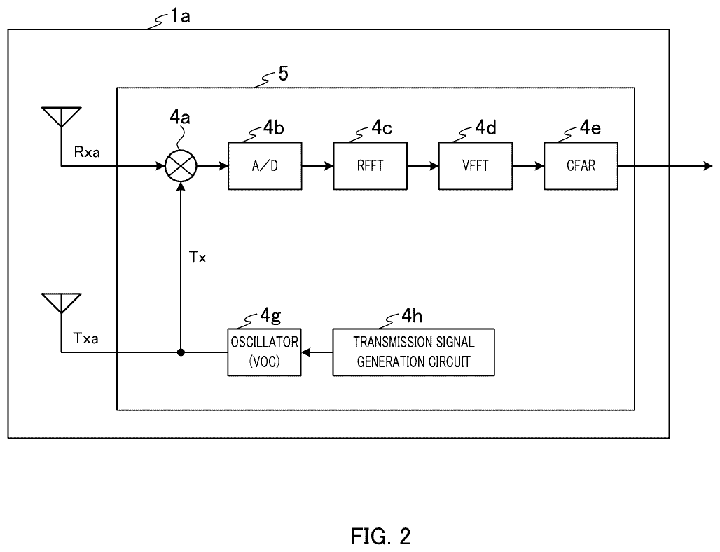

FIG. 2 illustrates an example of the block configuration of radar circuit (master chip) 1a. As illustrated in FIG. 2, radar circuit (master chip) 1a includes transmission antenna Txa, reception antenna Rxa, and SoC 5. SoC 5 includes mixer 4a, A/D (hereinafter, also referred to as A/D converter) 4b, RFFT 4c, VFFT 4d, CFAR 4e, oscillator (hereinafter, also referred to as VCO) 4g, and transmission signal generation circuit 4h. Radar circuit (master chip) 1a includes, for example, each block illustrated in FIG. 2 according to the number of transmission/reception antennas included in front-end module 1.

Mixer 4a receives reception signal Rxa, which is received by the reception antenna, and the transmission signal, which is output to the transmission antenna Txa. Mixer 4a mixes (multiplies) the reception signal and the transmission signal, and outputs the beat signal to A/D converter 4b. Note that the transmission signal is a chirp signal with a linearly changing frequency. The reception signal is a reflection wave (reflection signal) resulting from reflection of the chirp signal on an object. The transmission signal is generated by transmission signal generation circuit 4h. A chirp signal, for example, in the millimeter wave band is generated by oscillator 4g and transmitted from transmission antenna Txa.

A/D converter 4b converts an analog beat signal output from mixer 4a into a digital beat signal.

RFFT 4c performs Fast Fourier Transform (FFT) processing on the beat signal output from A/D converter 4b. The peak value obtained from the FFT processing by RFFT 4c corresponds to the distance to the object.

VFFT 4d executes FFT processing on the signal output from RFFT 4c and outputs a distance-Doppler map where the signal power is maximized at the point of the Doppler frequency shift caused by the velocity difference between the radar apparatus and the object.

Based on the information (signal) obtained from the FFT processing by VFFT 4d, CFAR 4e extracts a signal component for a distance and velocity at which the object (reflecting object) is likely to be present. The signal processed by CFAR 4e is output to processing unit 2a via cable 3.

FIG. 2 illustrates an example of the functional blocks in radar circuit (master chip) 1a. Similarly, radar circuit (slave chip) 1b also includes the same functional blocks.

The description of FIG. 1 will be resumed. Processing unit 2a of back-end module 2 is constituted by, for example, a processor such as a Digital Signal Processor (DSP) or a Central Processing Unit (CPU). Processing unit 2a integratively processes signals output from radar circuit (master chip) 1a and radar circuit (slave chip) 1b, and performs estimation processing for the arrival direction of the reflected wave. The processing result of processing unit 2a is output to, for example, a vehicle control apparatus such as an Electronic Control Unit (ECU).

In the radar apparatus illustrated in FIG. 1, as described in FIG. 2, radar circuit (master chip) 1a and radar circuit (slave chip) 1b execute processing up to Constant False Alarm Rate (CFAR) processing and output signals that satisfy predetermined conditions to the subsequent stage. The transmission rate of the signal output from front-end module 1 to processing unit 2a may be lower compared to the case where the beat signal is transmitted directly to processing unit 2a, because radar circuits (master chip) 1a and (slave chip) 1b execute the processing up to the CFAR processing beforehand. By reducing the transmission rate of the signal, the cost of chips, cables, and other components used for signal transmission can be reduced, for example.

However, since multiple SoCs execute signal processing independently in the radar apparatus illustrated in FIG. 1, there may be cases where the object detection performance decreases.

For example, in an existing radar apparatus, when performing interference suppression processing on a reception signal (or beat signal), the signal powers at all the reception antennas are summed, and it is determined whether the peak component of the summed power exceeds an allowable value.

In contrast, in the radar apparatus illustrated in FIG. 1, each of the plurality of SoCs adds the reception powers from the reception antennas connected to the SoC and executes interference suppression processing. For example, the radar apparatus illustrated in FIG. 1 performs interference suppression processing based on the sum of the signal powers from some of the reception antennas, without adding the reception powers from all the reception antennas included in the radar apparatus. For this reason, it may be difficult for each of the plurality of SoCs to appropriately determine whether a peak component is generated by interference or by signal variation.

Further, when a existing radar apparatus determines the peak component as caused by interference, the existing radar apparatus performs a control for suppressing the peak signal at the timing when the peak component is identified.

In contrast, in the radar apparatus illustrated in FIG. 1, each of the plurality of SoCs executes the interference suppression processing independently. As a result, it is difficult to perform signal suppression at the same timing for reception signals from all the reception antennas, which may lead to a decrease in the detection performance for an object.

Such a decrease in performance similarly occurs during CFAR processing. For example, in the CFAR processing, the signal-to-noise ratio of a peak signal is improved by summing the powers of the reception signals from all the reception antennas and performing a peak detection search.

However, since each of the plurality of SoCs independently performs peak detection search in the radar apparatus illustrated in FIG. 1, the addition of reception powers is limited to some reception antennas. For this reason, in the radar apparatus illustrated in FIG. 1, the signal-to-noise ratio in the CFAR processing may decrease, potentially leading to a reduction in the detection performance of objects.

Based on the above study, the present disclosure aims to suppress a decrease in the object detection performance in a radar apparatus.

### <Study 2>

A front-end module equipped with an antenna is installed in a limited location because it outputs radio waves. In order to improve the ease of installation into a vehicle, the front-end module, whose installation location is limited, is miniaturized.

Compared to the front-end module, the back-end module is not limited in terms of installation location and may include, for example, a device (processing unit) such as a DSP or a CPU that generates a large amount of heat. Further, the front-end module may transmit the digitally converted beat signal to the back-end module through a cable. By including the aforementioned device in the back-end module, the volume occupied by heat dissipation apparatuses such as heat sinks or cooling fans in the front-end module is reduced, thereby allowing the front-end module to be made more compact.

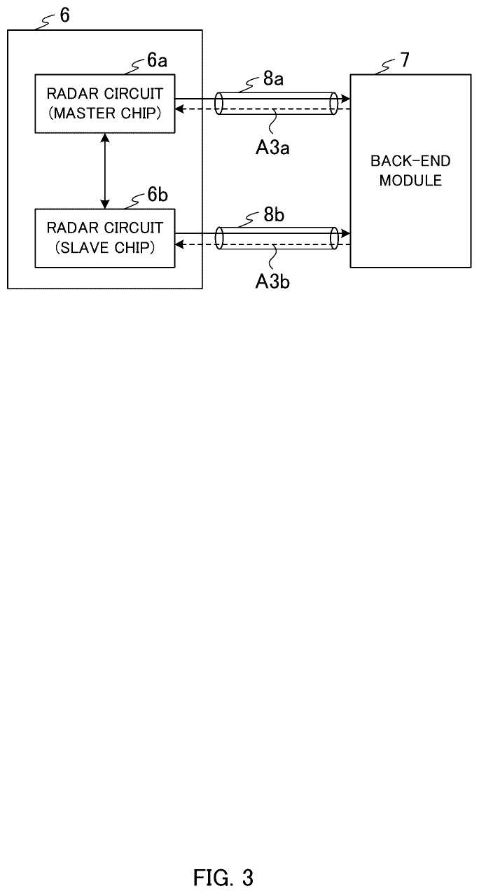

The radar apparatus having another block configuration illustrated in FIG. 3 includes front-end module 6, radar circuit (master chip) 6a, radar circuit (slave chip) 6b, back-end module 7, and cables 8a and 8b. Cable 8a connects radar circuit (master chip) 6a to back-end module 7. Cable 8b connects radar circuit (slave chip) 6b to back-end module 7.

Each of radar circuit (master chip) 6a and radar circuit (slave chip) 6b includes a transmission antenna and a reception antenna. Further, each of radar circuits (master chip) 6a and (slave chip) 6b has the function of mixing the transmission signal and the reception signal and outputting a beat signal. The beat signal of radar circuit (master chip) 6a is output to back-end module 7 via cable 8a. The beat signal of radar circuit (slave chip) 6b is output to back-end module 7 via cable 8b.

Back-end module 7 outputs control signals to radar circuit (master chip) 6a and radar circuit (slave chip) 6b via cables 8a and 8b.

Note that a channel through which the beat signal is transmitted may be referred to as a forward channel. A channel through which the control signal is transmitted may be referred to as a back channel. In the forward channel, transmission occurs at a higher rate than in the back channel. Hereinafter, the control signal may be referred to as a control command. Additionally, the SoC of the radar circuit (master chip) 6a may be referred to as the “master SoC,” and the SoC of radar circuit (slave chip) 6b may be referred to as the “slave SoC.”

Various control commands are transmitted to the SoC mounted on the radar circuit, for example, after power is supplied to the radar apparatus or after the radar apparatus is reset. For example, in the radar apparatus shown in FIG. 3, after the power is turned on, control commands for starting the SoCs are transmitted from back-end module 7 to radar circuit (master chip) 6a and radar circuit (slave chip) 6b via the back channels (see broken-line arrows A3a and A3b in FIG. 3).

More specifically, after the power is turned on, back-end module 7 uses the control command to first start the slave SoC in order to synchronize the operation of multiple SoCs. After confirming that the slave SoC is prepared to receive inputs of a local signal, a frame period signal, and/or the like for synchronization, back-end module 7 starts the master SoC using the control command. After the master SoC is started, back-end module 7 uses the control command to output the local signal and the frame period signal from the master SoC to the slave SoC.

However, as described above, the transmission rate of the back channel is lower compared to that of the forward channel. For this reason, for example, when the radar apparatus is started, various control commands may be transmitted from back-end module 7 to radar circuit (master chip) 6a and radar circuit (slave chip) 6b, which may result in a longer starting time for the radar apparatus. When the starting time is long, it is difficult for a driver to start driving, for example, until starting the radar apparatus is completed after the vehicle engine is started.

Based on the above study, the present disclosure aims to shorten the starting time in the SoC (radio processor) of the front-end module.

### Embodiment 1

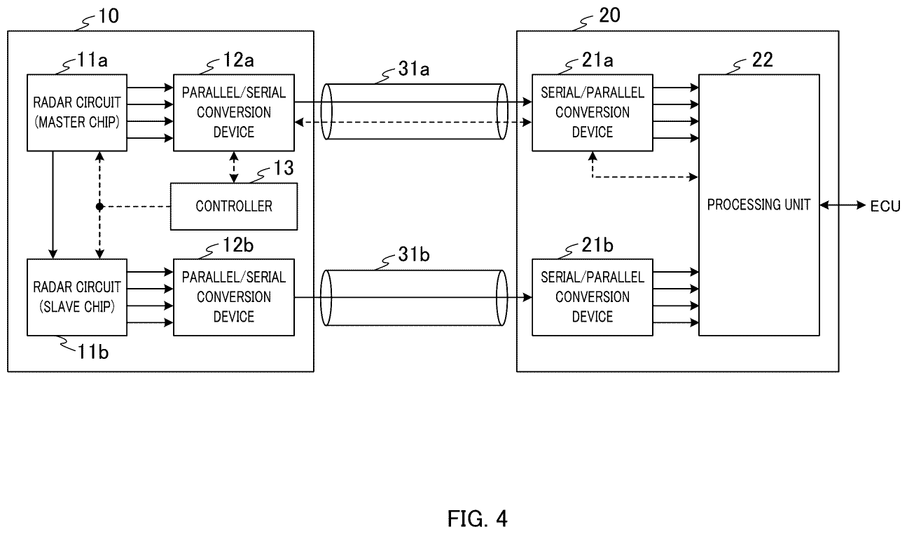

As illustrated in FIG. 4, the radar apparatus includes front-end module 10, back-end module 20, and cables 31a and 31b. Front-end module 10 and back-end module 20 are connected via cables 31a and 31b. Cables 31a and 31b are, for example, coaxial cables. Front-end module 10 and back-end module 20 transmit and receive signals based on, for example, Low Voltage Differential Signaling (LVDS).

### <Front-End Module>

Front-end module 10 includes radar circuit (master chip) 11a, radar circuit (slave chip) 11b, parallel/serial conversion devices (hereinafter, may be simply referred to as conversion devices) 12a and 12b, and controller 13.

Conversion device 12a is, for example, constituted by a single chip. Conversion device 12b is, for example, constituted by a single chip. Conversion devices 12a and 12b may also be referred to as serializers.

The number of radar circuits (slave chips) 11b and conversion devices 12b corresponding radar circuits (slave chips) 11b are not limited to the example shown in FIG. 4. For example, in a case where it is desired to increase the number of antennas in a radar apparatus, the number of radar circuits (slave chips) and the corresponding conversion devices are increased. In a case where it is desired to reduce the number of antennas in a radar apparatus, the number of radar circuits (slave chips) and the number of conversion devices corresponding to the radar circuits (slave chips) are reduced.

Radar circuit (master chip) 11a, radar circuit (slave chip) 11b, conversion devices 12a and 12b, and controller 13 are configured on, for example, a single substrate. By configuring each part (each chip) on a single substrate, signals between the parts are transmitted at high speed. Of course, each part may also be configured on separate substrates. In this case, the distance between the substrates is shortened to prevent the transmission speed of signals between the components from decreasing.

### <Radar Circuit of Front-End Module>

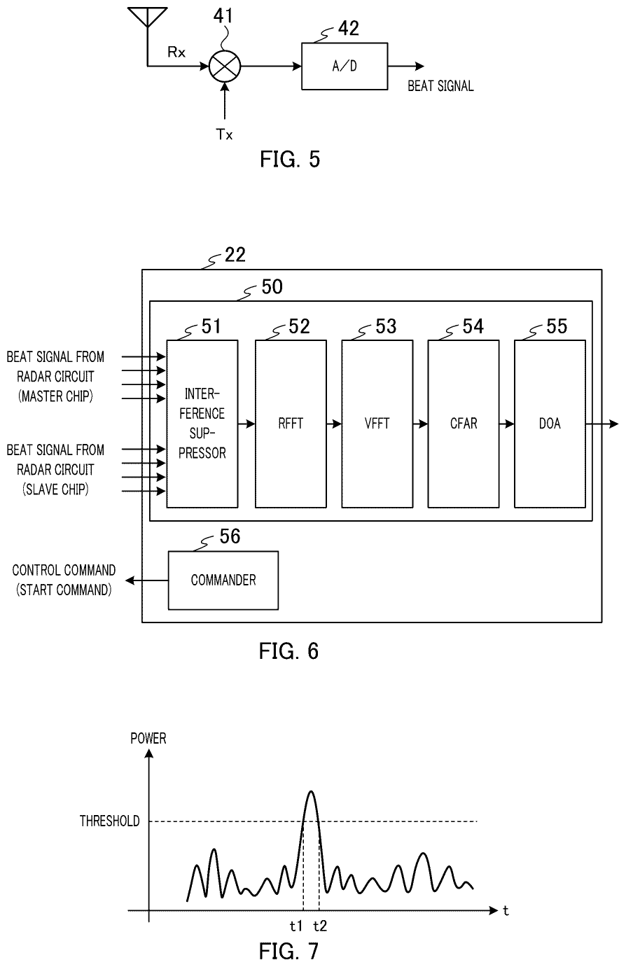

As illustrated in FIG. 5, radar circuit (master chip) 11a includes mixer 41 and A/D converter 42. Radar circuit (master chip) 11a includes, for example, the blocks illustrated in FIG. 2 that front-end module 10 includes and each of which corresponds in number to the reception antenna.

In Mixer 41, reception signal Rx received by the reception antenna and transmission signal Tx output to a transmission antenna (not illustrated) are input. Mixer 41 mixes reception signal Rx and transmission signal Tx, and outputs the beat signal to A/D converter 42. Note that transmission signal Tx is a chirp signal with a linearly changing frequency. Reception signal Rx is a reflection wave (reflection signal) resulting from reflection of a chirp signal by an object.

A/D converter 42 converts the analog beat signal output from mixer 41 into a digital beat signal. A/D converter 42 outputs the beat signal, which has been converted into a digital signal, to conversion device 12a. The digital beat signal output from A/D converter 42 may be a serial signal.

Note that radar circuit (master chip) 11a outputs beat signals corresponding in number to the reception antennas to conversion device 12a. For example, when radar circuit (master chip) 11a has four reception antennas, radar circuit (master chip) 11a outputs four beat signals to conversion device 12a (for example, refer to the four arrows from radar circuit (master chip) 11a in FIG. 4 toward conversion device 12a). For example, radar circuit (master chip) 11a outputs the beat signals from the respective multiple reception antennas in parallel.

Note that the number of reception antennas and the number of parallel signals do not necessarily need to match. It is sufficient that the signals are transmitted in parallel according to a predetermined format. The use of the configuration the same as in the case where a signal is output by an image sensor for image acquisition is advantageous because existing design assets can be utilized.

Further, FIG. 5 illustrates an example of a functional block in radar circuit (master chip) 11a, and radar circuit (slave chip) 11b also includes the same functional block.

Further, radar circuit (master chip) 11a and radar circuit (slave chip) 11b may each have a transmission antenna and a reception antenna. For example, a transmission antenna and a reception antenna may be formed on the SoC.

### <Conversion Device of Front-End Module>

The description of FIG. 4 will be resumed. Conversion device 12a is connected to serial/parallel conversion device 21a of back-end module 20 via, for example, single cable 31a such as a coaxial cable. Conversion device 12b is connected to serial/parallel conversion device 21b of back-end module 20 via, for example, single cable 31b such as a coaxial cable.

Digital beat signals from respective reception antennas are input in parallel to conversion device 12a. For example, as described above, when front-end module 10 includes four reception antennas, four beat signals are input to conversion device 12a in parallel.

Note, as described above, the number of reception antennas and the number of parallel signals do not necessarily have to match. It is sufficient that the signals are transmitted in parallel according to a predetermined format. The use of the configuration the same as in the case where a signal is output by an image sensor for image acquisition is advantageous because existing design assets can be utilized.

Conversion device 12a converts parallel beat signals into a serial format and outputs them to cable 31a. For example, conversion device 12a time-division-multiplexes four parallel beat signals and outputs them to cable 31a.

Conversion device 12a has a reverse link function. For example, conversion device 12a performs bi-directional communication. Conversion device 12a receives a control command transmitted from processing unit 22 of back-end module 20 via cable 31a and outputs the control command to controller 13.

Conversion device 12a transmits signals using two channels with different transmission rates. For example, conversion device 12a includes a forward channel and a back channel that operates at a lower rate than the forward channel. Conversion device 12a transmits the beat signal to back-end module 20 using the forward channel. Conversion device 12a receives control commands from processing unit 22 of back-end module 20 using the back channel.

In the above description, conversion device 12a has been explained, but conversion device 12b also possesses the same functions. In the above, controller 13 communicates with processing unit 22 of back-end module 20 via conversion device 12a corresponding to radar circuit (master chip) 11a, but controller 13 may also communicate with processing unit 22 of back-end module 20 via conversion device 12b corresponding to radar circuit (slave chip) 11b.

### <Controller of Front-End Module>

Controller 13 is constituted by, for example, a one-chip microcomputer, a CPU, a DSP, or an SoC including a memory, and operates based on software (or firmware).

As described above, controller 13 communicates with processing unit 22 of back-end module 20 via the back channel. Controller 13 controls radar circuit (master chip) 11a and radar circuit (slave chip) 11b in accordance with control commands, such as start commands, from processing unit 22 of back-end module 20.

### <Start Operation Example of Controller of Front-End Module>

Controller 13 receives a start command from processing unit 22 of back-end module 20. Controller 13 controls the start of radar circuit (master chip) 11a and radar circuit (slave chip) 11b in accordance with the start command from processing unit 22.

For example, controller 13 outputs specific control commands to start radar circuit (master chip) 11a and radar circuit (slave chip) 11b in response to the start command from processing unit 22. For example, since controller 13 is responsible for the specific starting control of radar circuit (master chip) 11a and radar circuit (slave chip) 11b, processing unit 22 of back-end module 20 may use a low-rate back channel to start radar circuit (master chip) 11a and radar circuit (slave chip) 11b without transmitting a series of multiple control commands for the starting control to front-end module 10.

More specifically, when controller 13 receives the start command from processing unit 22, controller 13 outputs the start command to radar circuit (slave chip) 11b. Controller 13 autonomously outputs the start command to radar circuit (master chip) 11a (for example, without receiving the control command from processing unit 22) after confirming that radar circuit (slave chip) 11b has been started in response to the start command and is prepared to receive inputs of a local signal, a frame period signal, and/or the like for synchronization.

After radar circuit (master chip) 11a is started, controller 13 autonomously outputs a synchronization command to radar circuit (master chip) 11a. In response to the synchronization command from controller 13, radar circuit (master chip) 11a outputs the local signal and the frame period signal to radar circuit (slave chip) 11b.

As described above, controller 13 is responsible for the specific starting control of radar circuit (master chip) 11a and radar circuit (slave chip) 11b in response to the start command from processing unit 22. For this reason, the control processing (steps) of radar circuit (master chip) 11a and radar circuit (slave chip) 11b using the low-rate back channel by processing unit 22 is reduced, and the starting time of radar circuit (master chip) 11a and radar circuit (slave chip) 11b is shortened.

### <Calibration Operation Example of Controller of Front-End Module>

Transmission/reception antennas that operate in high-frequency bands, such as millimeter waves, may exhibit individual differences due to manufacturing variations. Additionally, SoCs such as radar circuit (master chip) 11a and radar circuit (slave chip) 11b may exhibit individual differences due to manufacturing.

Accordingly, it is preferable to perform calibration according to the characteristics of each individual unit, for example, before factory shipment. Storing calibration values in a memory of controller 13 eliminates the need to integrally manage front-end module 10 and back-end module 20 for calibration purposes, and it is thus advantageous for quality management and manufacturing management. For example, since the calibration values corresponding to individual characteristics are stored in front-end module 10 (controller 13), front-end module 10 can exhibit optimal performance regardless of the specific characteristics of back-end module 20.

Further, the calibration control processing (procedure) of radar circuit (master chip) 11a and radar circuit (slave chip) 11b using a low-rate back channel by processing unit 22 is reduced, and the starting time in radar circuit (master chip) 11a and radar circuit (slave chip) 11b is shortened.

The calibration values may include, for example, a back-off value (such as an attenuation value of an attenuator) to maintain constant transmission power, a reception amplification rate to ensure consistent reception levels across the respective antenna branches, and phase difference information between the antenna branches to perform high-accuracy arrival direction estimation. The back-off value and the reception amplification rate are each used (configured) in radar circuit (master chip) 11a and radar circuit (slave chip) 11b. The phase difference information is used in processing unit 22 of back-end module 20. For example, processing unit 22 makes a read access request to controller 13 via the back channel and acquires the phase difference information from controller 13 via the forward channel at the time of starting. In the processing of estimating the arrival direction of the reflection wave, processing unit 22 performs the estimation with high accuracy using the phase difference information acquired from controller 13.

Note that multiple pieces of configuration information, such as the periodicity and bandwidth of the chirp signal, may be stored in the memory of controller 13. For example, processing unit 22 may, at the start time, instruct controller 13 to configure the periodicity and bandwidth of the chirp signal to be applied to radar circuit (master chip) 11a and radar circuit (slave chip) 11b. Controller 13 may configure the periodicity and bandwidth of the chirp signal as indicated by processing unit 22 for radar circuit (master chip) 11a and radar circuit (slave chip) 11b.

### <Back-End Module>

Back-end module 20 will be described. Back-end module 20 includes serial/parallel conversion devices (sometimes simply referred to as conversion devices) 21a and 21b, and processing unit 22.

Conversion device 21a is, for example, constituted by a single chip. Conversion device 21b is, for example, constituted by a single chip. Processing unit 22 is, for example, constituted by a processor such as a DSP or a CPU, or by an SoC. Conversion devices 21a and 21b may also be referred to as deserializers.

Conversion devices 21a and 21b and processing unit 22 are configured on, for example, a single substrate. By configuring each part (each chip) on a single substrate, signals between the parts are transmitted at high speed. Of course, each section may be configured on a separate substrate. In this case, the distance between the substrates is shortened to prevent the transmission speed of signals between the components from decreasing.

### <Conversion Device of Back-End Module>

Serial beat signals output from conversion device 12a of front-end module 10 are input to conversion device 21a. Conversion device 21a converts the serial beat signals into parallel beat signals and outputs the parallel beat signals to processing unit 22. For example, when four beat signals corresponding to four reception antennas are input, conversion device 21a converts the four beat signals into four parallel signals and outputs the four parallel signals to processing unit 22.

Note, as described above, the number of reception antennas and the number of parallel signals do not necessarily have to match. It is sufficient that the signals are transmitted in parallel according to a predetermined format. The use of the configuration the same as in the case where a signal is output by an image sensor for image acquisition is advantageous because existing design assets can be utilized.

Conversion device 21a has a reverse link function. For example, conversion device 21a performs bidirectional communication. Conversion device 21a transmits a control command output from processing unit 22 via cable 31a to conversion device 12a of front-end module 10.

Conversion device 21a transmits signals using two channels with different transmission rates. Conversion device 21a receives a beat signal from front-end module 10 using a forward channel. Conversion device 21a transmits the control command from processing unit 22 to front-end module 10 using a back channel.

Conversion device 21a has been described above. Conversion device 21b also has the same function.

### <Processing Unit of Back-End Module>

Beat signals (digital) converted in parallel by conversion devices 21a and 21b are input to processing unit 22. For example, front-end module 10 is responsible for the output processing of the beat signal, while back-end module 20 is responsible for the signal processing for object detection using the beat signal.

Processing unit 22 performs object detection processing based on the input beat signals. As described above, since the beat signals from the respective reception antennas included in front-end module 10 are input into processing unit 22, the object detection processing is performed without being limited to the beat signals from a part of the reception antennas. For example, processing unit 22 performs object detection processing on the beat signals from all the reception antennas. Processing unit 22 outputs an object detection processing result to a vehicle control apparatus such as an ECU.

As illustrated in FIG. 6, processing unit 22 includes detector 50 and commander 56. Detector 50 includes interference suppressor 51, RFFT 52, VFFT 53, CFAR 54, and DOA 55. DOA stands for Direction Of Arrival.

Beat signals output from conversion devices 21a and 21b are input to interference suppressor 51. For example, beat signals output from radar circuit (master chip) 11a of front-end module 10 and beat signals output from radar circuit (slave chip) 11b are input into interference suppressor 51.

The powers of the reception signals (beat signals) received by the reception antenna may increase due to interference. Interference suppressor 51 suppresses beat signals with power exceeding a predetermined value.

Interference suppressor 51 sums the power of the input beat signals. In a case where the added power exceeds a predetermined value, interference suppressor 51 suppresses the input beat signal at the timing when the added power exceeds the predetermined value.

For example, as illustrated in FIG. 7, the summed power of the beat signals exceeds a threshold from time t1 to time t2. In this case, interference suppressor 51 suppresses the beat signal input during the time period from t1 to t2.

Interference suppressor 51 performs power addition for the beat signals in radar circuit (master chip) 11a and the beat signals in radar circuit (slave chip) 11b. For example, interference suppressor 51 adds together the beat signals from all the reception antennas included in front-end module 10. Thus, interference suppressor 51 prevents erroneous detection of interference such as exceedance of the threshold by a beat signal which caused by an influence of a thermal noise that varies independently in each reception antenna system, thereby enabling appropriate suppression of signal variations truly caused by interference.

Referring again to FIG. 6. RFFT 52 performs FFT processing on the beat signals output from interference suppressor 51. A peak value obtained by the FFT processing in RFFT 52 corresponds to the distance to the object.

VFFT 53 executes FFT processing on the signal output from RFFT 52 and outputs a distance-Doppler map where the signal power is maximum at the point of the Doppler frequency shift caused by the velocity difference between the radar apparatus and the object.

CFAR 54 extracts signal components for distances and velocities at which an object (reflecting object) is likely to be present, based on the information (signal) from the distance-Doppler map obtained by the FFT processing in RFFT 52 and VFFT 53.

DOA 55 estimates the arrival direction of the object based on the signal output from CFAR 54. Further, DOA 55 calculates the reliability of the estimated arrival direction. DOA 55 outputs the estimated arrival direction of the object and its reliability to a vehicle control apparatus such as an ECU.

CFAR 54 and DOA 55 execute the detection processing without being limited to the beat signals of some of the reception antennas. For example, CFAR 54 and DOA 55 sum the powers of the beat signals from all the reception antennas and perform peak detection search. Thus, in the processing of CFAR 54 and DOA 55, the signal-to-noise ratio of the peak signal is improved, enhancing the object detection performance of CFAR 54 and DOA 55.

Here, as illustrated in FIG. 5, front-end module 10 is responsible for the output processing of the beat signal for each of the reception antennas. As illustrated in FIG. 6, back-end module 20 is responsible for signal processing after the beat signals are output. Thus, back-end module 20 can perform signal processing on the beat signals from the plurality of reception antennas, for example, over the entirety of radar circuit (master chip) 11a and radar circuit (slave chip) 11b all at once, rather than individually for each of radar circuit (master chip) 11a and radar circuit (slave chip) 11b. For this reason, the radar apparatus can prevent a decrease in the object detection performance.

When the radar apparatus is started, commander 56 transmits a start command to conversion devices 12a, 12b, 21a, and 21b. Examples of the start include turning on the power of the radar apparatus. In addition, the start includes, for example, a start (restart) due to a reset of the radar apparatus.

Conversion devices 12a, 12b, 21a, and 21b start in response to the start command. When the start is completed successfully, conversion devices 12a, 12b, 21a, and 21b send a start completion command indicating the successful completion of the start to commander 56.

When commander 56 receives the start completion command from conversion devices 12a, 12b, 21a, and 21b, commander 56 transmits a start command to controller 13. For example, commander 56 transmits a start command to controller 13 after front-end module 10 and back-end module 20 are in a state where communication between them is possible.

Note that the apparatuses such as conversion devices 12a, 12b, 21a, 21b, controller 13, radar circuit (master chip) 11a, and radar circuit (slave chip) 11b are assigned addresses. Commander 56 designates, based on the addresses, the apparatus to which a control command such as a start command is to be transmitted. For example, the apparatus assigned an address by commander 56 receives a control command, such as the start command, output from commander 56.

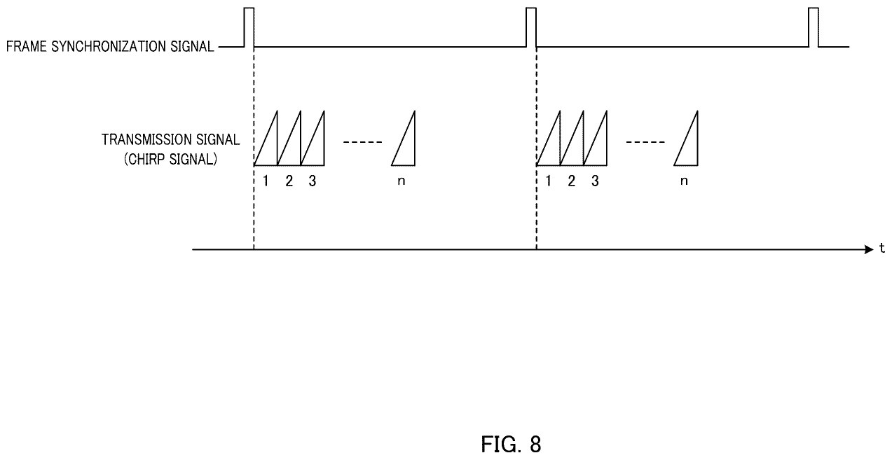

The processing timing of processing unit 22 will be described. FIG. 8 illustrates a frame synchronization signal output from radar circuit (master chip) 11a to radar circuit (slave chip) 11b as described in FIG. 4. Further, FIG. 8 illustrates the transmission signals (chirp signals) output from radar circuit (master chip) 11a and radar circuit (slave chip) 11b.

Note that the signal transmitted from radar circuit (master chip) 11a to radar circuit (slave chip) 11b may be 1/M of the frequency output from the transmission antenna. In this case, the radar circuit (slave chip) multiplies the chirp signal by M and then transmits the chirp signal from the transmission antenna. For example, a configuration is assumed in which the center frequency of the signal transmitted from radar circuit (master chip) 11a to radar circuit (slave chip) 11b is 20 GHz, and after being quadrupled in the radar circuit (slave chip), the signal with a center frequency of 80 GHz is transmitted from the transmission antenna.

Radar circuit (master chip) 11a and radar circuit (slave chip) 11b output a group of chirp signals (n signals in FIG. 8) in synchronization with the frame synchronization signal. Processing unit 22 executes object detection processing once per cycle of the frame synchronization signal. For example, processing unit 22 outputs detection results such as the distance, velocity, direction estimation (arrival direction estimation of the reflection wave), and reliability in the direction for each cycle of the frame synchronization signal.

### <Summary of Embodiment 1>

As described above, the radar apparatus includes front-end module 10, back-end module 20, and cables 31a and 31b that connect front-end module 10 to back-end module 20. Front-end module 10 includes radar circuit (master chip) 11a and radar circuit (slave chip) 11b, each of which outputs a plurality of beat signals in a plurality of respective reception antennas, and controller 13 that executes the starting control of radar circuit (master chip) 11a and radar circuit (slave chip) 11b in accordance with the start command received from back-end module 20 via cable 31a. Back-end module 20 includes detector 50 that detects objects based on the plurality of beat signals received from front-end module 10 via cables 31a and 31b; and commander 56 that outputs the start command based on the start of the radar apparatus.

With this configuration, front-end module 10 is responsible for processing up to the output of the beat signal in each of the plurality of reception antennas, and back-end module 20 (detector 50) is responsible for detecting objects based on the beat signals output from front-end module 10.

Detector 50 can, for example, perform signal processing on the beat signals from multiple reception antennas collectively, thereby preventing a decrease in object detection performance.

Further, with the above configuration, controller 13 of front-end module 10 executes the starting process of radar circuit (master chip) 11a and radar circuit (slave chip) 11b in response to the start command from commander 56 of back-end module 20.

To start radar circuit (master chip) 11a and radar circuit (slave chip) 11b, back-end module 20 does not need to transmit multiple control commands to front-end module 10. This reduces the low-rate communication between front-end module 10 and back-end module 20, thereby shortening the starting time of the radar apparatus.

### Embodiment 2

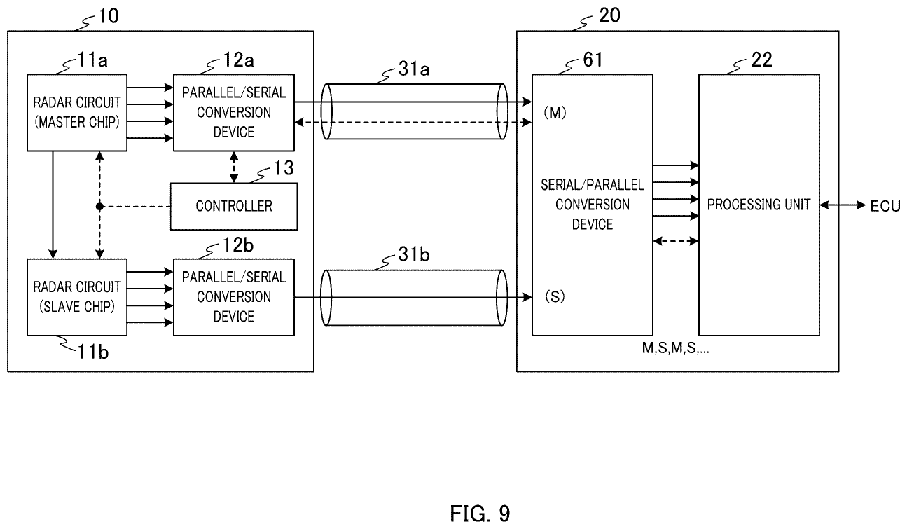

In Embodiment 2, the back-end module includes one conversion device. One conversion device in the back-end module time-divisionally processes beat signals output from the master radar and the radar circuit (slave chip) of the front-end module, and outputs the beat signals to the processing unit. In FIG. 9, the same components as those in FIG. 4 are denoted by the same reference numerals.

As illustrated in FIG. 9, back-end module 20 includes single conversion device 61. Conversion device 61 is constituted by, for example, a single chip. Cables 31a and 31b are connected to conversion device 61.

Conversion device 61 receives the beat signals from radar circuit (master chip) 11a of front-end module 10 via cable 31a. Conversion device 61 receives the beat signals using the forward channel.

Conversion device 61 transmits a control command to controller 13 of front-end module 10 via cable 31a. Conversion device 61 transmits the control command using the back channel.

Conversion device 61 receives the beat signals from radar circuit (slave chip) 11b of front-end module 10 via cable 31b. Conversion device 61 receives the beat signals using the forward channel.

Conversion device 61 converts the serial beat signals from radar circuit (master chip) 11a of front-end module 10 into parallel signals. For example, when conversion device 61 receives four serial beat signals corresponding to four reception antennas in radar circuit (master chip) 11a, conversion device 61 converts the four serial beat signals into four parallel signals. Hereinafter, the parallel signals for radar circuit (master chip) 11a, which are parallel-converted by conversion device 61, may be referred to as parallel signals M.

Conversion device 61 converts the serial beat signals in radar circuit (slave chip) 11b of front-end module 10 into parallel signals. For example, when conversion device 61 receives four beat signals corresponding to four reception antennas in radar circuit (slave chip) 11b, conversion device 61 converts these four beat signals into four parallel signals. Hereinafter, the parallel signals for radar circuit (slave chip) 11b, which are parallel-converted by conversion device 61, may be referred to as parallel signals S.

Conversion device 61 time-divisionally outputs parallel signals M and parallels signal S to processing unit 22. For example, conversion device 61 outputs parallel signals M and parallel signals S to processing unit 22 in a time-division manner, as in parallel signals M, S, M, S, and so forth.

### <Summary of Embodiment 2>

As described above, conversion device 61 time-divisionally separates parallel signals M and parallel signals S and outputs them to processing unit 22. Thus, the number of pins in conversion device 61 can be reduced, leading to cost savings. Additionally, even if the number of input pins of processing unit 22 is limited, conversion device 61 can still be connected to processing unit 22.

### <Variation of Embodiment 2>

Processing unit 22 (commander 56) understands the order of parallel signals M and S output from conversion device 61 after transmission of the starting instruction to front-end module 10 (controller 13). For example, processing unit 22 is aware that the output starts with parallel signal M and continues in the order of parallel signals S, M, S, and so forth. After starting front-end module 10, processing unit 22 performs object detection processing based on the premise that the parallel signals are output from conversion device 61 in the order: M, S, M, S, and so forth.

In a case where processing unit 22 stops the operations of radar circuit (master chip) 11a and radar circuit (slave chip) 11b of front-end module 10, signals in radar circuit (slave chip) 11b may remain on a transmission path depending on the timing at which processing unit 22 stops front-end module 10. For example, parallel signals S may remain in a buffer of conversion device 61 in FIG. 9. Alternatively, the serial signals of the beat signals in radar circuit (slave chip) 11b may remain in the buffer of conversion device 12b in FIG. 9.

More specifically, processing unit 22 transmits a control command, such as a stop command, to controller 13. In response to the stop command from processing unit 22, controller 13 addresses radar circuit (master chip) 11a and stops the operation of radar circuit (master chip) 11a. Next, controller 13 addresses radar circuit (slave chip) 11b and stops the operation of radar circuit (slave chip) 11b. In a case where the timing for stopping the operation of radar circuit (slave chip) 11b is in the frame following the frame in which radar circuit (master chip) 11a is stopped, the signal in radar circuit (slave chip) 11b may remain on the transmission path.

As described above, when the operations of radar circuit (master chip) 11a and radar circuit (slave chip) 11b are resumed while parallel signal S or the like remains on the transmission path, parallel signal S is first output to processing unit 22, followed by the output of parallel signals M, S, M, and so forth. In this case, the parallel signals in an order different from the order recognized by processing unit 22 are input into processing unit 22, making it difficult to execute the object detection processing appropriately.

Accordingly, when controller 13 receives a stop command from processing unit 22 (commander 56) and it is difficult to stop the operations of radar circuit (master chip) 11a and radar circuit (slave chip) 11b within one frame, controller 13 will stop the operations of radar circuit (master chip) 11a and radar circuit (slave chip) 11b in the next frame. For example, when controller 13 receives a stop command from processing unit 22, controller 13 stops the operations of radar circuit (master chip) 11a and radar circuit (slave chip) 11b within the same frame.

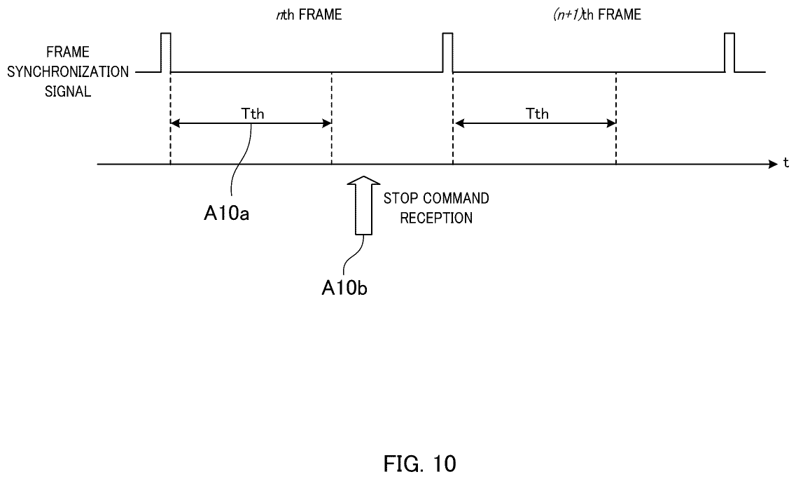

A situation is assumed where radar circuit (slave chip) controller 13 receives the stop command from processing unit 22 as indicated by arrow A10b after the elapse of stop processing time Tth indicated by double arrow A10a from the start of the nth frame illustrated in FIG. 10.

In this case, controller 13 executes an operation stop process on radar circuit (master chip) 11a and radar circuit (slave chip) 11b in the (n+1)th frame, which is the frame following the nth frame. For example, controller 13 executes the operation stop process on radar circuit (master chip) 11a and radar circuit (slave chip) 11b before stop processing time Tth for the (n+1)th frame elapses.

Note that stop processing time Tth is, for example, a time period which, once this stop processing time Tth elapsed after the start of one frame, makes it difficult for radar circuit (master chip) 11a and radar circuit (slave chip) 11b to complete the stop processing within the same frame.

As described above, when controller 13 receives a stop command from processing unit 22, controller 13 stops the operations of radar circuit (master chip) 11a and radar circuit (slave chip) 11b within the same frame.

Thus, when the operations of radar circuit (master chip) 11a and radar circuit (slave chip) 11b are stopped and then restarted, parallel signals in the appropriate order are output from conversion device 61, allowing the processing unit to execute the object detection process appropriately.

### Embodiment 3

In Embodiment 3, multiple front-end modules are connected to a back-end module.

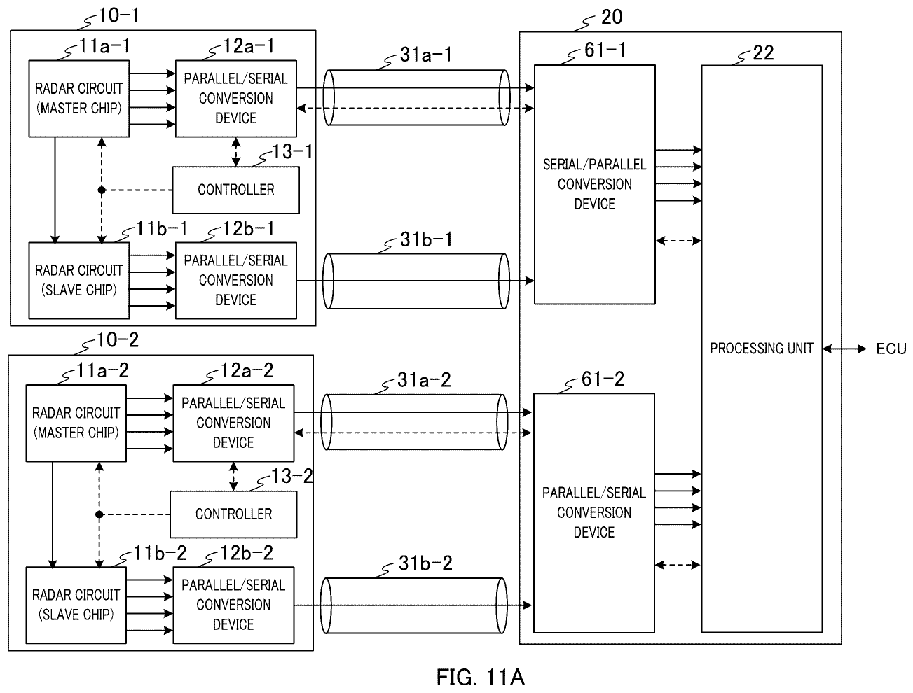

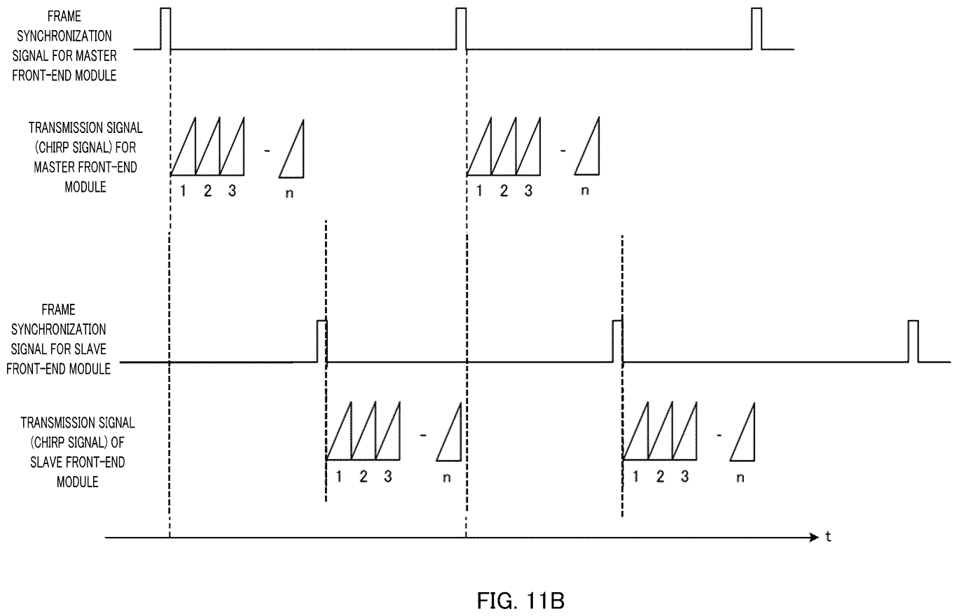

As illustrated in FIG. 11A, the radar apparatus includes two front-end modules 10-1 and 10-2, and one back-end module 20. Front-end module 10-1 is connected to back-end module 20 via two cables 31a-1 and 31b-1, such as coaxial cables. Front-end module 10-2 is connected to back-end module 20 via two cables 31a-2 and 31b-2, such as coaxial cables.

Front-end module 10-1 is the same as the front-end module 10 described in FIGS. 4 and 9, and the description thereof will be omitted. Front-end module 10-2 is also the same as front-end module 10 described in FIGS. 4 and 9, and its description will be omitted.

Back-end module 20 includes two conversion devices 61-1 and 61-2. Conversion devices 61-1 and 61-2 have the same functions as conversion device 61 described in FIG. 9. Conversion device 61-1 outputs beat signals from front-end module 10-1 to processing unit 22. Conversion device 61-2 outputs beat signals from front-end module 10-2 to processing unit 22.

As described in FIG. 9, the number of connection pins between conversion device 61-1 and processing unit 22 is reduced by conversion device 61-1. Correspondingly to the reduction in the number of connection pins of conversion device 61-1 in processing unit 22, front-end module 10-2 is added, and conversion device 61-2 corresponding to front-end module 10-2 is connected to processing unit 22.

Processing unit 22 synchronizes the frame synchronization signals of front-end modules 10-1 and 10-2.

For example, processing unit 22 transmits a frame synchronization command to each of front-end modules 10-1 and 10-2. In accordance with the frame synchronization command from processing unit 22, controller 13-1 of front-end module 10-1 synchronizes the frame synchronization signals between radar circuit (master chip) 11a-1 and radar circuit (slave chip) 11b-1. In accordance with the frame synchronization command from processing unit 22, controller 13-2 of front-end module 10-2 synchronizes the frame synchronization signals between radar circuit (master chip) 11a-2 and radar circuit (slave chip) 11b-2.

Thus, the frame synchronization signals for radar circuits (master chip) 11a-1 and (slave chip) 11b-1 within front-end module 10-1 are synchronized. The frame synchronization signals for radar circuits (master chip) 11a-2 and (slave chip) 11b-2 within front-end module 10-2 are synchronized. Further, the frame synchronization signal for front-end module 10-1 is synchronized with the frame synchronization signal for front-end module 10-2.

Note that processing unit 22 may use a control command to alternately transmit a transmission signal (chirp signal) from front-end module 10-1 and front-end module 10-2.

In this case, processing unit 22 may perform the detection processing based on the beat signals output from the other front-end module while transmission signals are being transmitted from one of the front-end modules.

Further, in a case where front-end modules 10-1 and 10-2 transmit transmission signals alternately, front-end modules 10-1 and 10-2 may transmit the transmission signals in the same frequency band. Note that, as illustrated in FIG. 11B, even when the same frequency band is utilized, the master front-end module transmission signals and the slave front-end module transmission signals are alternately transmitted from front-end module 10-1 and front-end module 10-2, which makes it possible to suppress interference. Further, the radar apparatus can make effective use of the frequency.

In the above description, the case where the number of front-end modules is two has been explained, but the number of front-end modules is not limited to two. The front-end module may include three or more units.

### <Summary of Embodiment 3>

As described above, the radar apparatus includes multiple front-end modules 10-1 and 10-2. Thus, the radar apparatus can increase or decrease the number of transmission/reception antennas in units of front-end modules 10-1 and 10-2. By installing front-end modules 10-1 and 10-2 in different directions, it is possible to widen the system's viewing angle.

Additionally, when front-end modules 10-1 and 10-2 transmit transmission signals alternately, front-end modules 10-1 and 10-2 can transmit transmission signals in the same frequency band. Thus, the radar apparatus improves the efficiency of frequency utilization.

### <Variation of Embodiment 3>

In the above, processing unit 22 synchronizes the frame synchronization signal of front-end module 10-1 with the frame synchronization signal of front-end module 10-2, but the present disclosure is not limited to this. The controller of one of the plurality of front-end modules may synchronize the frame synchronization signals of the plurality of front-end modules.

For example, controller 13-1 of front-end module 10-1 illustrated in FIG. 11A and controller 13-2 of front-end module 10-2 are connected to each other by a cable. Controller 13-1 outputs the frame synchronization signal of controller 13-1 to controller 13-2 via the cable. Controller 13-2 synchronizes the frame synchronization signal for controller 13-1 with the frame synchronization signal output from controller 13-2. Thus, front-end module 10-1 and front-end module 10-2 can synchronize their frame synchronization signals.

Note that front-end module 10 that transmits the frame synchronization signal may be referred to as a master front-end module. Front-end module 10 that receives the frame synchronization signal may be referred to as a slave front-end module.

### Embodiment 4

In Embodiment 4, the front-end module includes one conversion device. The back-end module has one conversion device.

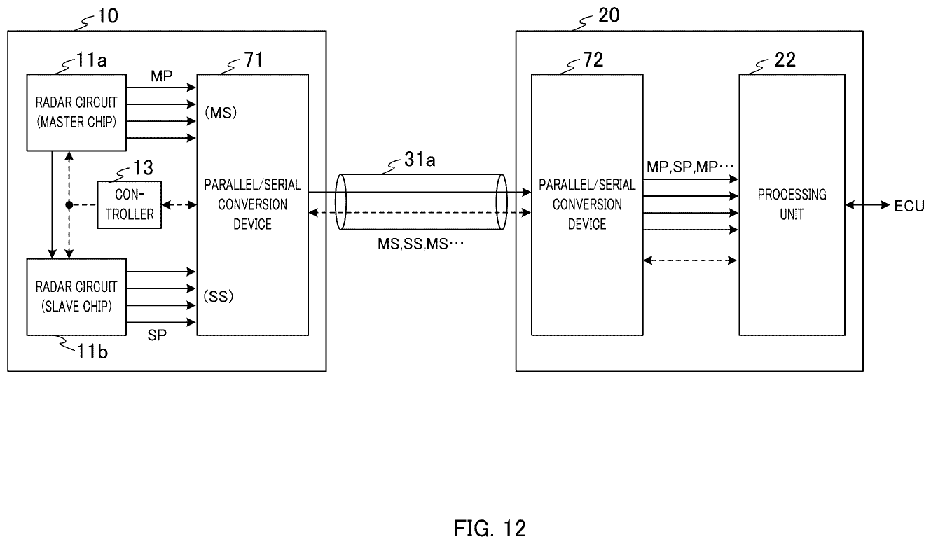

In FIG. 12, the same components as those in FIG. 4 are denoted by the same reference numerals.

### <Conversion Device of Front-End Module>

Front-end module 10 includes conversion device 71. Radar circuit (master chip) 11a and radar circuit (slave chip) 11b are connected to conversion device 71. One cable 31a, such as a coaxial cable, is connected to conversion device 71.

In conversion device 71, digital beat signals from respective reception antennas connected to radar circuit (master chip) 11a are input in parallel. For example, when four reception antennas are connected to radar circuit (master chip) 11a, four beat signals are input to conversion device 71 in parallel. Note that the number of reception antennas and the number of parallel signals do not necessarily have to match. It is sufficient that the signals are transmitted in parallel according to a predetermined format. The use of the configuration the same as in the case where a signal is output by an image sensor for image acquisition is advantageous because existing design assets can be utilized. Conversion device 71 converts parallel beat signals (sometimes referred to as parallel signals MP) output from radar circuit (master chip) 11a into serial signals (sometimes referred to as serial signals MS).

Conversion device 71 receives digital beat signals in parallel from respective reception antenna connected to radar circuit (slave chip) 11b. For example, when four reception antennas are connected to radar circuit (slave chip) 11b, four beat signals are input to conversion device 71 in parallel. Note that the number of reception antennas and the number of parallel signals do not necessarily have to match. It is sufficient that the signals are transmitted in parallel according to a predetermined format. The use of the configuration the same as in the case where a signal is output by an image sensor for image acquisition is advantageous because existing design assets can be utilized. Conversion device 71 converts parallel beat signals (sometimes referred to as parallel signals SP) output from radar circuit (slave chip) 11b into serial signals (sometimes referred to as serial signals SS).

Conversion device 71 time-divisionally separates the beat signals in radar circuit (master chip) 11a subjected to serial conversion (serial signals MS) and the beat signals in radar circuit (slave chip) 11b subjected to serial conversion (serial signals SS), and outputs these signals to cable 31a. For example, conversion device 72 outputs the serial signals to cable 31a alternately in the order of serial signals MS, SS, MS, and so forth.

### <Conversion Device of Back-End Module>

Back-end module 20 includes conversion device 72. Conversion device 72 is connected to cable 31a. Conversion device 72 is connected to processing unit 22.

Conversion device 72 receives serial signal MS and serial signal SS output from conversion device 71 via cable 31a. Conversion device 72 converts the received serial signal MS and serial signal SS into parallel signals and outputs them to processing unit 22.

For example, conversion device 72 converts received serial signals MS into parallel signals MP and outputs parallel signals MP to processing unit 22. For example, conversion device 72 decodes received serial signals MS back into the state of parallel beat signals (beat signals for respective reception antennas) as output by radar circuit (master chip) 11a of front-end module 10, and outputs these parallel beat signals to processing unit 22.

Further, for example, conversion device 72 converts received serial signals SS into parallel signals SP and outputs them to processing unit 22. For example, conversion device 72 converts received serial signals SS back to the state of parallel beat signals (beat signals for respective reception antennas) output by radar circuit (slave chip) 11b of front-end module 10, and outputs these parallel signals to processing unit 22.

As described above, the serial signals are alternately output from conversion device 71 of front-end module 10 in the order of serial signals MS, SS, MS, and so forth. For example, the parallel signals are output from conversion device 72 of back-end module 20 to processing unit 22 alternately in the order of parallel signals MP, SP, MP, and so forth.

Note that, in the case where the operation of the radar apparatus is stopped in Embodiment 4, the operation described in the variation of Embodiment 2 may be applied. For example, when controller 13 receives a stop command from processing unit 22, controller 13 stops the operations of radar circuit (master chip) 11a and radar circuit (slave chip) 11b within the same frame.

### <Summary of Embodiment 4>

As described above, the radar apparatus includes conversion device 71 that converts parallel signals MP output from radar circuit (master chip) 11a into serial signals MS, and converts parallel signals SP output from radar circuit (slave chip) 11b into serial signals SS, and outputs serial signals MS and SS to cable 31a in a time-division manner. Further, the radar apparatus includes conversion device 72 that converts (restores) serial signals MS into parallel signals MP, converts (restores) serial signals SS into parallel signals SP, and outputs restored parallel signals MP and SS to processing unit 22 in a time-division manner.

With this configuration, the radar apparatus can reduce the number of cables 31a, thereby achieving cost reduction. Further, since the number of pins in processing unit 22 can be reduced, the radar apparatus can achieve cost reduction.

### Embodiment 5

For example, in large vehicles such as trucks, the front-end module and the back-end module may be installed far apart from each other. In this case, there is a possibility that the signal communicated between the front-end module and the back-end module may deteriorate.

Accordingly, in Embodiment 5, a reproduction apparatus is provided between the front-end module and the back-end module.

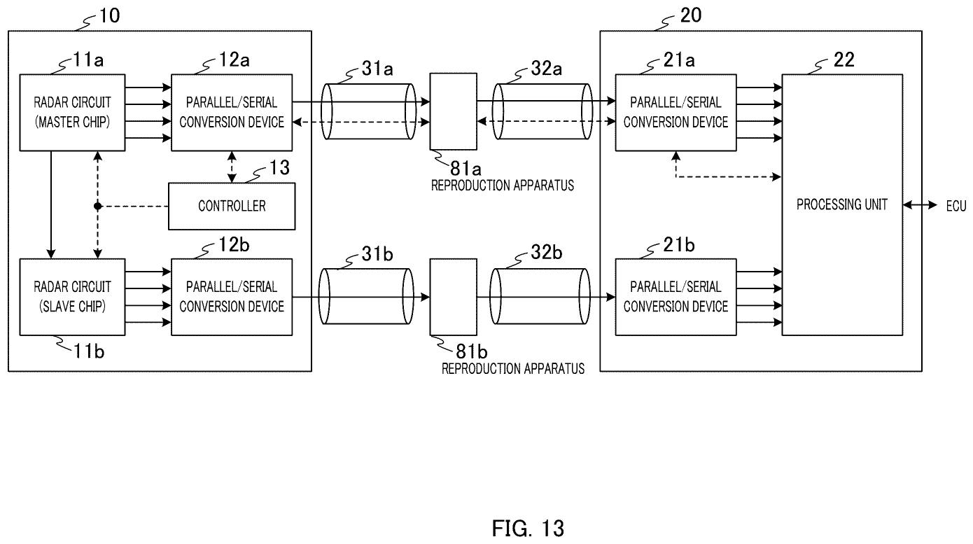

In FIG. 13, the same components as those in FIG. 4 are denoted by the same reference numerals. As illustrated in FIG. 13, the radar apparatus includes reproduction apparatuses 81a and 81b between front-end module 10 and back-end module 20. Reproduction apparatuses 81a and 81b may also be referred to as relay apparatuses or reproduction relay apparatuses.

### <Reproduction Apparatus>

Reproduction apparatus 81a is connected to conversion device 12a of front-end module 10 via cable 31a. Reproduction apparatus 81a is connected to conversion device 21a of back-end module 20 via cable 32a.

Reproduction apparatus 81a reproduces (shapes the waveform of) the signal communicated between front-end module 10 and back-end module 20. For example, reproduction apparatus 81a includes a serial/parallel conversion device and a parallel/serial conversion device. Reproduction apparatus 81a converts a serial signal received from front-end module 10 into a parallel signal using the serial/parallel conversion device, then converts the parallel signal back into the serial signal using the parallel/serial conversion device, and transmits the serial signal to back-end module 20.

Note that reproduction apparatus 81a may shape the waveform of the serial signal received from front-end module 10 as it is (without converting the signal into a parallel signal) and transmit the signal to back-end module 20. The waveform shaping may include amplification of the signal.

Reproduction apparatus 81b is connected to conversion device 12b of front-end module 10 via cable 31b. Reproduction apparatus 81b is connected to conversion device 21b of back-end module 20 via cable 32b. Reproduction apparatus 81b has the same functions as reproduction apparatus 81a, and thus the description will be omitted.

### <Operation Example of Reproduction Apparatus>

In the case where reproduction apparatus 81a includes the serial/parallel conversion device and the parallel/serial conversion device, addresses are assigned to both the serial/parallel conversion device and the parallel/serial conversion device. In the case where reproduction apparatus 81b also includes the serial/parallel conversion device and the parallel/serial conversion device, similar to reproduction apparatus 81a, addresses are assigned to both the serial/parallel conversion device and the parallel/serial conversion device.

When the radar apparatus is started, processing unit 22 of back-end module 20 designates reproduction apparatuses 81a and 81b using addresses, in the same manner as conversion devices 12a, 12b, 21a, and 21b described in Embodiment 1, and transmits start commands to reproduction apparatuses 81a and 81b. Reproduction apparatuses 81a and 81b are started in response to the start commands. When the starting is completed normally, reproduction apparatuses 81a and 81b transmit an start completion command to processing unit 22, indicating that the starting is completed normally.

In the case where processing unit 22 receives the start completion command from reproduction apparatuses 81a and 81b, processing unit 22 transmits the start command to controller 13. For example, processing unit 22 transmits the start command to controller 13 after reproduction apparatuses 81a and 81b are in a state where communication is possible.

### <Summary of Embodiment 5>

As described above, the radar apparatus includes reproduction apparatuses 81a and 81b between front-end module 10 and back-end module 20. Thus, front-end module 10 and back-end module 20 can perform long-distance communication, making the radar apparatus applicable to large vehicles such as trucks.

### Embodiment 6

In Embodiment 6, the processing unit detects faults in the master radar and/or the radar circuit (slave chip).

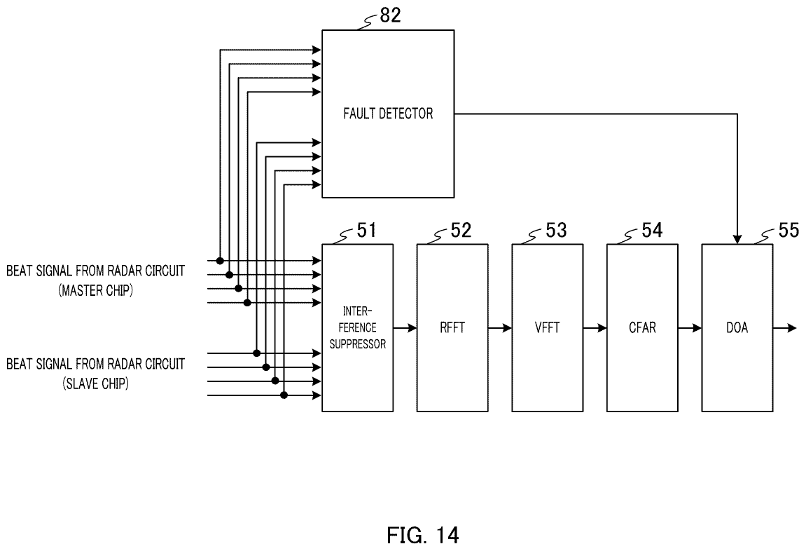

In FIG. 14, the same components as those in FIG. 6 are denoted by the same reference numerals. In FIG. 14, processing unit 22 includes fault detector 82.

A beat signal output from conversion device 21a (see FIG. 4) is input to fault detector 82. For example, the beat signal from each antenna connected to radar circuit (master chip) 11a is input to fault detector 82.

A beat signal output from conversion device 21b (see FIG. 4) is input to fault detector 82. For example, the beat signal from each antenna connected to radar circuit (slave chip) 11b is input to fault detector 82.

Fault detector 82 detects faults in radar circuit (master chip) 11a and radar circuit (slave chip) 11b based on the input beat signals. For example, in a case where the beat signals in radar circuit (master chip) 11a remain ‘0’ for a certain period or longer, fault detector 82 determines that radar circuit (master chip) 11a is faulty. In a case where the beat signals in radar circuit (slave chip) 11b are ‘0’ for a certain period or more, fault detector 82 determines that radar circuit (slave chip) 11b is faulty.

Fault detector 82 outputs a fault determination result to DOA 55. DOA 55 executes the estimation process for the arrival direction of an object based on the determination result from fault detector 82.

For example, when DOA 55 receives the determination result from fault detector 82 indicating that radar circuit (master chip) 11a is faulty, DOA 55 executes the estimation process for the arrival direction based on the beat signal in radar circuit (slave chip) 11b. Further, in a case where DOA 55 receives a determination result from fault detector 82 that radar circuit (slave chip) 11b is faulty, DOA 55 executes the estimation process for the arrival direction based on the beat signal in radar circuit (master chip) 11a.

In the case where either radar circuit (master chip) 11a or radar circuit (slave chip) 11b is faulty, a grating lobe, which is not generated during the arrival direction estimation using all the antennas of both radar circuit (master chip) 11a and radar circuit (slave chip) 11b, may be generated. Accordingly, DOA 55 also estimates multiple directions that are potential candidates for the arrival direction estimation result. Then, the minimum functions up to stopping vehicle, for example, are secured for the ECU in the subsequent stage.

Further, in the event that either radar circuit (master chip) 11a or radar circuit (slave chip) 11b is faulty, the signal-to-noise ratio of the reception signal (beat signal) may deteriorate. In this case, the distance within which a reflecting object having a small reflection sectional area is detectable may become shorter. In a case where a fault is determined by fault detector 82, it is desirable that the process executed in the subsequent ECU takes into account, for example, the shortening of the detection distance.

Furthermore, in the above description, fault detector 82 performs fault detection in the entirety of radar circuit (master chip) 11a and the entirety of radar circuit (slave chip) 11b, but the present disclosure is not limited to this. For example, as described above, the beat signal from each reception antenna is input into fault detector 82. Fault detector 82 may determine a fault for each function (for example, circuit) corresponding to each reception antenna of radar circuit (master chip) 11a and for each function corresponding to each reception antenna of radar circuit (slave chip) 11b. For example, fault detector 82 may detect a fault in radar circuit (master chip) 11a and/or radar circuit (slave chip) 11b for each reception antenna.

### <Summary of Embodiment 6>

As described above, processing unit 22 includes fault detector 82 that detects failures in radar circuit (master chip) 11a and/or radar circuit (slave chip) 11b based on a plurality of beat signals. Thus, the minimum necessary functions up to stopping vehicle, for example, can be secured for the ECU in the subsequent stage of the radar apparatus based on the failure result.

### Embodiment 7

In Embodiment 7, the beat signals output from the radar circuit (master chip) and the radar circuit (slave chip) of the front-end module are compressed and transmitted to the back-end module. In the back-end module, the compressed beat signals are expanded and output to the processing unit.

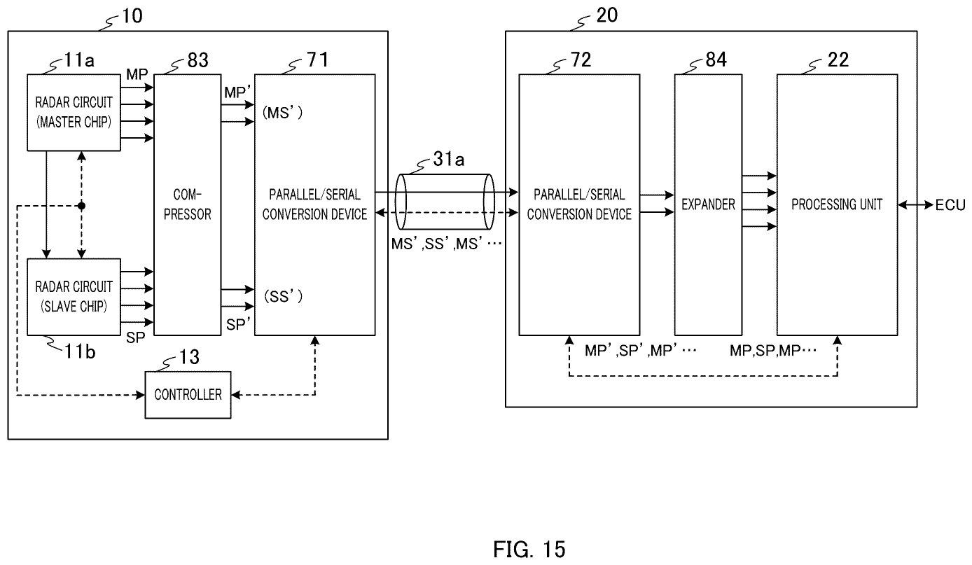

In FIG. 15, the same components as those in FIG. 12 are denoted by the same reference numerals. As illustrated in FIG. 15, front-end module 10 includes compressor 83. Back-end module 20 includes expander 84.

### <Compressor of Front-End Module>

Parallel signals MP output from radar circuit (master chip) 11a are input to compressor 83. Compressor 83 compresses input parallel signals MP and outputs compressed parallel signals MP′ to conversion device 71.

Additionally, parallel signals SP output from radar circuit (slave chip) 11b are input to compressor 83. Compressor 83 compresses input parallel signals SP and outputs compressed parallel signals SP′ to conversion device 71.

Note that, as described in FIG. 12, conversion device 71 of front-end module 10 converts input parallel signals MP′ into serial signals MS′. Conversion device 71 converts input parallel signal SP′ into serial signals SS′. Conversion device 71 outputs serial signals MS' and serial signals SS' to cable 31a in a time-division manner. For example, conversion device 72 outputs the serial signals to cable 31a alternately in the order of serial signals MS′, SS′, MS′, and so forth.

### <Expander of Back-End Module>

Conversion device 72 of back-end module 20 receives serial signals MS' and serial signals SS' output from conversion device 71 via cable 31a. Conversion device 72 converts received serial signals MS' and serial signals SS' into parallel signals and outputs them to expander 84.

For example, conversion device 72 converts received serial signals MS' into parallel signals MP′ and outputs them to expander 84. For example, conversion device 72 returns received serial signals MS' to the state of compressed parallel beat signals in radar circuit (master chip) 11a and outputs them to expander 84.

Further, for example, conversion device 72 converts received serial signals SS' into parallel signals SP′ and outputs them to expander 84. For example, conversion device 72 converts received serial signals SS' back to the state of compressed parallel beat signals in radar circuit (slave chip) 11b and outputs them to expander 84.

As described above, serial signals MS′, SS′, MS′, and so forth are alternately output from conversion device 71 in front-end module 10. For example, from conversion device 72 of back-end module 20, parallel signals are alternately output to processing unit 22 in the order of MP′, SP′, MP′, and so forth.

Expander 84 expands the parallel signals output from conversion device 72 and outputs the expanded signals to processing unit 22.

For example, expander 84 expands parallel signals MP′ output from conversion device 72 into parallel signals MP and outputs them to processing unit 22. For example, expander 84 returns compressed parallel signals MP′ output from conversion device 72 to the parallel beat signals (parallel signals MP) in radar circuit (master chip) 11a before compression, and outputs the parallel beat signals to processing unit 22.

Further, for example, expander 84 expands parallel signals SP′ output from conversion device 72 into parallel signals SP and outputs them to processing unit 22. For example, expander 84 returns compressed parallel signals SP′ output from conversion device 72 to the parallel beat signals (parallel signals SP) in the radar circuit (slave chip) 11b before compression, and outputs the parallel beat signals to processing unit 22.

### <Summary of Embodiment 7>

As described above, front-end module 10 includes compressor 83, and back-end module 20 includes expander 84. Thus, the radar apparatus can reduce the transmission rate between front-end module 10 and back-end module 20 so as to relax the specifications of cable 31a and achieve cost reduction.

### Embodiment 8

In Embodiment 8, the front-end module is daisy-chained in the radar apparatus described in Embodiment 7.

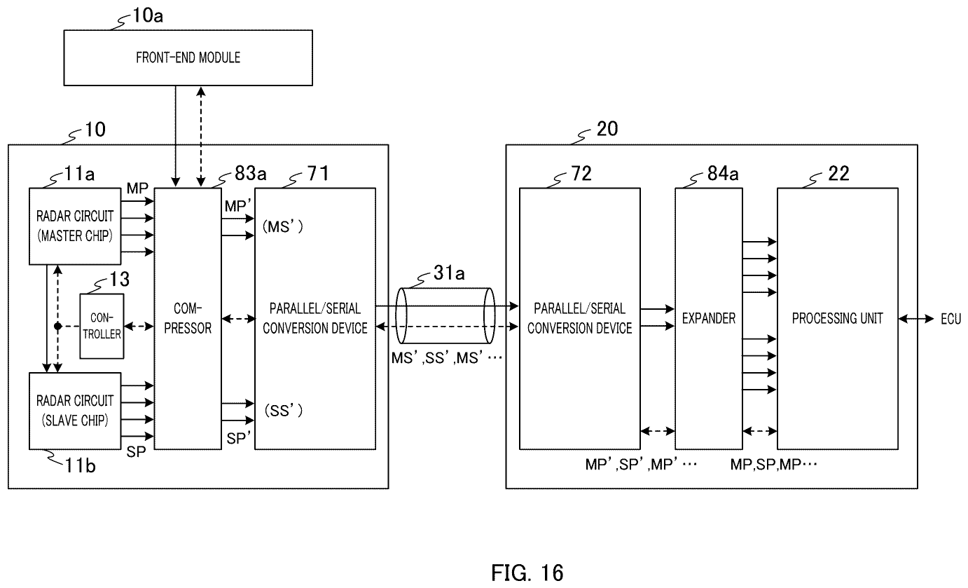

In FIG. 16, the same components as those in FIG. 15 are denoted by the same reference numerals. As illustrated in FIG. 16, the radar apparatus includes front-end module 10a.

Front-end module 10a includes a radar circuit (master chip), a radar circuit (slave chip), and a controller (not illustrated). The radar circuit (master chip), radar circuit (slave chip), and the controller of front-end module 10a have the same functions as radar circuit (master chip) 11a, radar circuit (slave chip) 11b, and controller 13 illustrated in FIG. 16, respectively.

The beat signals output from the radar circuit (master chip) and the radar circuit (slave chip) of front-end module 10a are input to compressor 83a of front-end module 10.

Compressor 83a has a multiplexing function that multiplexes signals with respect to compressor 83 as described in FIG. 15. For example, compressor 83a compresses the beat signals output from radar circuit (master chip) 11a and radar circuit (slave chip) 11b of front-end module 10, as well as the beat signals output from the radar circuit (master chip) and the radar circuit (slave chip) of front-end module 10a. The compressed beat signals from the two front-end modules are then output to conversion device 71 in a time-division manner.

Expander 84a of back-end module 20 includes a separation function that separates the multiplexed beat signals of front-end modules 10 and 10a, with respect to expander 84a as described in FIG. 15. Expander 84a outputs the separated beat signals from front-end module 10 and the separated beat signals from front-end module 10a to processing unit 22 in parallel.

As illustrated in FIG. 16, front-end module 10a (controller) communicates with back-end module 20 via compressor 83a. For this reason, as shown in FIG. 16, compressor 83a and expander 84a, unlike compressor 83a and expander 84a described in FIG. 15, include a back channel for transmitting and receiving control commands.

Note that compressor 83 and expander 84 described in FIG. 15 may also have a back channel. In this case, controller 13 illustrated in FIG. 15 is connected to compressor 83. Additionally, the wiring for connecting processing unit 22 and conversion device 72 shown in FIG. 15 is unnecessary.

### <Summary of Embodiment 8>

As described above, parallel beat signals from front-end module 10a, which is different from front-end module 10, are input into compressor 83a of front-end module 10. Thus, since front-end module 10a is daisy-chained to front-end module 10, a cable for connecting front-end module 10a and back-end module 20 is not necessary, thereby reducing the cost of the radar apparatus.

### Embodiment 9

In Embodiment 9, the front-end module is daisy-chained in the radar apparatus described in Embodiment 4 (FIG. 12).

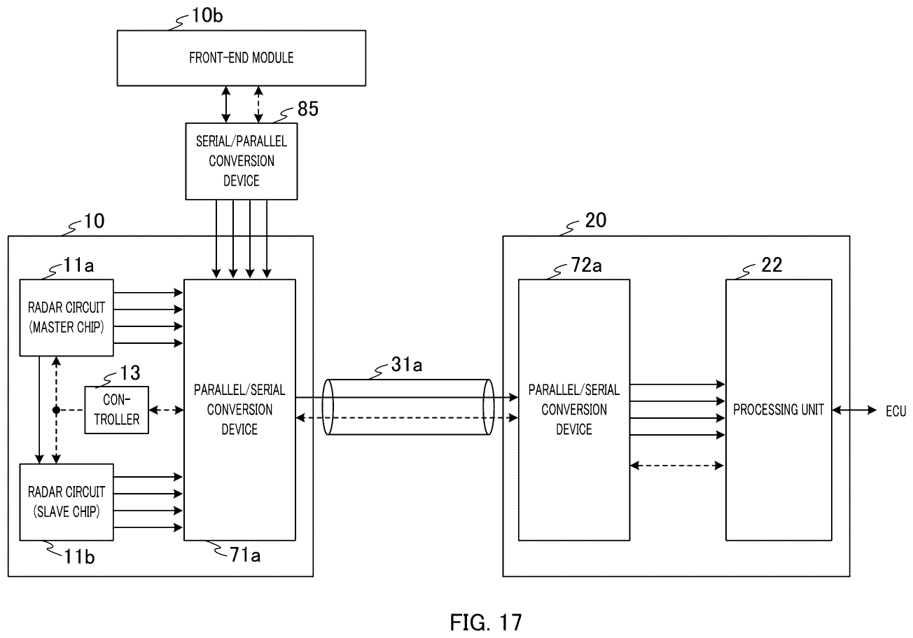

In FIG. 17, the same components as those in FIG. 12 are denoted by the same reference numerals. As illustrated in FIG. 17, the radar apparatus includes front-end module 10b and serial/parallel conversion device 85. Hereinafter, serial/parallel conversion device 85 may be referred to as the conversion device.

Front-end module 10b has the same configuration as front-end module 10. The output of the conversion device (not illustrated) included in front-end module 10b is sent to conversion device 85.

Conversion device 85 converts the serial beat signals output from front-end module 10b into parallel beat signals and outputs the parallel beat signals to conversion device 71 of front-end module 10.

Front-end module 10 includes conversion device 71a. Conversion device 71a includes a multiplexing function that multiplexes signals, with respect to conversion device 71 described in FIG. 12.

For example, conversion device 71a converts the beat signals output from radar circuit (master chip) 11a and radar circuit (slave chip) 11b into serial signals. Further, conversion device 71a converts beat signals of front-end module 10b, which are output from conversion device 85, into serial signals. Conversion device 71a time-divisionally multiplexes the beat signals of radar circuit (master chip) 11a and radar circuit (slave chip) 11b, both of which have been converted into serial signals, and the beat signals of conversion device 85, which has also been converted into serial signals, and outputs the time-divisionally multiplexed beat signals to cable 31a. For example, conversion device 71a alternately outputs to cable 31a the beat signals of radar circuit (master chip) 11a and the beat signals of radar circuit (slave chip) 11b, both converted into serial signals, and the beat signals of conversion device 85, also converted into a serial signal.

Back-end module 20 includes conversion device 72a. Conversion device 72a has a separation function that separates the multiplexed beat signals of front-end modules 10 and 10b into the beat signals of front-end module 10 and the beat signals of front-end module 10b, with respect to conversion device 72 as described in FIG. 12. Expander 84a alternately outputs the separated beat signals from front-end module 10 and the separated beat signal from front-end module 10b to processing unit 22.

### <Summary of Embodiment 9>

As described above, the radar apparatus includes conversion device 85 that converts serial signals output from front-end module 10b, which is different from front-end module 10, into parallel beat signals, and outputs the parallel beat signals to conversion device 71a of front-end module 10. Thus, the radar apparatus can connect three or more front-end modules in a daisy chain. Additionally, the radar apparatus can reduce the number of cables, thereby achieving cost reduction.

Although the embodiments have been described above with reference to the drawings, the present disclosure is not limited to these examples. Obviously, a person skilled in the art would arrive variations and modification examples within a scope described in claims. It is understood that these variations and modifications are within the technical scope of the present disclosure. Moreover, any combination of features of the above-mentioned embodiments may be made without departing from the spirit of the disclosure.

The front-end module and the back-end module may simply be referred to as modules. The front-end module and the back-end module may be regarded as housings. The radar circuit (slave chip) and the radar circuit (slave chip) may be referred to as a signal processor. The conversion device may be referred to as a converter.

In the description of the embodiment described above, the term, such as “part” or “portion” or the term ending with a suffix, such as “-er” “-or” or “-ar” may be replaced with another term, such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

### INDUSTRIAL APPLICABILITY

The present disclosure is useful, for example, in a radar apparatus mounted on a vehicle.

### REFERENCE SIGNS LIST

10 Front-end module
11a Radar circuit (master chip)
11b Radar circuit (slave chip)
12a, 12b Parallel/serial conversion device
20 Back-end module
21a, 21b Serial/parallel conversion device
22 Processing unit
31a, 31b Cable

1. A radar apparatus, comprising:
a first module;
a second module; and
a cable that connects the first module to the second module, wherein
the first module includes:
a signal processing circuit which, in operation, outputs a plurality of beat signals respectively for a plurality of reception antennas, and
a control circuit which, in operation, outputs a control command to the signal processing circuit in accordance with a start trigger command received from the second module via the cable, the control command being used for starting the signal processing circuit, and
the second module includes:
a detection circuit which, in operation, detects an object based on the plurality of beat signals received from the first module via the cable, and
a command circuit which, in operation, transmits the start trigger command to the first module.

2. The radar apparatus according to claim 1, wherein:
the plurality of reception antennas include a plurality of first reception antennas and a plurality of second reception antennas;
the signal processing circuit includes a first signal processing circuit and a second signal processing circuit, the first signal processing circuit outputting first beat signals respectively for the plurality of first reception antennas, the second signal processing circuit outputting second beat signals respectively for the plurality of second reception antennas, the first beat signals being parallel to one another, the second beat signals being parallel to one another;
the first module includes a first conversion circuit and a second conversion circuit, the first conversion circuit converting the first beat signals being parallel to one another into first serial signals and outputting the first serial signals to the cable, the second conversion circuit converting the second beat signals being parallel to one another into second serial signals and outputting the second serial signals to the cable; and
the second module includes a third conversion circuit that restores the first serial signals received via the cable into the first beat signals being parallel to one another, restores the second serial signals received via the cable into the second beat signals being parallel to one another, and outputs to the detection circuit the first beat signals restored and the second beat signals restored.

3. The radar apparatus according to claim 1, wherein:
the plurality of reception antennas include a plurality of first reception antennas and a plurality of second reception antennas;
the signal processing circuit includes a first signal processing circuit and a second signal processing circuit, the first signal processing circuit outputting first beat signals respectively for the plurality of first reception antennas, the second signal processing circuit outputting second beat signals respectively for the plurality of second reception antennas, the first beat signals being parallel to one another, the second beat signals being parallel to one another;
the first module includes a first conversion circuit and a second conversion circuit, the first conversion circuit converting the first beat signals being parallel to one another into first serial signals and outputting the first serial signals to the cable, the second conversion circuit converting the second beat signals being parallel to one another into second serial signals and outputting the second serial signals to the cable; and
the second module includes a third conversion circuit that restores the first serial signals received via the cable into the first beat signals being parallel to one another, restores the second serial signals received via the cable into the second beat signals being parallel to one another, and multiplexes in a time-division manner the first beat signals restored and the second beat signals restored, to output the first beat signals and the second beat signals to the detection circuit.

4. The radar apparatus according to claim 2, wherein
when receiving a stop command from the command circuit via the cable, the control circuit stops an operation of the first signal processing circuit and the second signal processing circuit within one frame.

5. The radar apparatus according to claim 2, wherein:
the first module comprises a plurality of the first modules, and the third conversion circuit comprises a plurality of the third conversion circuits; and
the plurality of third conversion circuits are provided to correspond respectively to the plurality of first modules,
wherein each of the plurality of third conversion circuits which, in operation, restores serial signals output from a corresponding first module into first beat signals being parallel to one another and second beat signals being parallel to one another, and multiplexes in a time-division manner the first bear signals restored and the second beat signals restored, to output the first bear signals and the second beat signals to the detection circuit.

6. The radar apparatus according to claim 1, wherein:
the plurality of reception antennas include a plurality of first reception antennas and a plurality of second reception antennas;
the signal processing circuit includes a first signal processing circuit that outputs first beat signal respectively for the plurality of first reception antennas in parallel, and a second signal processing circuit that outputs a second beat signal respectively for the plurality of second reception antennas in parallel;
the first module includes a first conversion circuit that converts the first beat signals being parallel to one another into first serial signals, converts the second beat signals being parallel to one another into second serial signals, and multiplexes the first serial signals and the second serial signals in a time-division manner to output the first and the second serial signals to the cable; and
the second module includes a second conversion circuit that restores the first serial signals received via the cable into the first beat signals being parallel to one another, restores the second serial signals received via the cable into the second beat signals being parallel to one another, and multiplexes in a time-division manner the first beat signals restored and the second beat signals restored, to output the first beat signals and the second beat signals to the detection circuit.

7. The radar apparatus according to claim 6, wherein:
the first module includes a compression circuit that compresses the first beat signals being parallel to one another output from the first signal processing circuit and the second beat signals being parallel to one another output from the second signal processing circuit, and outputs the first and the second beat signals to the first conversion circuit; and
the second module includes an expansion circuit that expands the first beat signals being parallel to one another and the second beat signals being parallel to one another output from the second conversion circuit.

8. The radar apparatus according to claim 7, wherein:
the first module comprises a plurality of the first modules; and
beat signals being parallel to one another from a first module different from the first module are input to the compression circuit.

9. The radar apparatus according to claim 6, further comprising:
a third conversion circuit that converts a serial signal output from a module different from the first module into a parallel beat signal and outputs the parallel beat signal to the first conversion circuit of the first module.

10. The radar apparatus according to claim 1, further comprising:
a reproduction circuit between the first module and the second module, the reproduction circuit shaping a waveform of a signal transmitted.

11. The radar apparatus according to claim 1, wherein
the detection circuit detects a fault in the signal processing circuit based on the plurality of beat signals.

12. A radar signal processing method, comprising:
transmitting a start trigger command from a command circuit of a second module to a control circuit of a first module via a cable connecting the first module to the second module;
receiving, by the control circuit of the first module, the start trigger command from the second module;
outputting, in response to the start trigger command, a control command from the control circuit of the first module to a signal processing circuit of the first module, the control command being used for starting the signal processing circuit of the first module;
outputting, from the signal processing circuit started of the first module to a detection circuit of the second module, a plurality of beat signals respectively for a plurality of reception antennas connected to the signal processing circuit of the first module; and
detecting, by the detection circuit of the second module, an object based on the plurality of beat signals received from the first module via the cable.

13. The radar signal processing method according to claim 12, wherein:
the plurality of beat signals include first beat signals being parallel to one another for a plurality of first reception antennas from among the plurality of reception antennas, and second beat signals being parallel to one another for a plurality of second reception antennas from among the plurality of reception antennas;
the first beat signals being parallel to one another are converted into first serial signals by a first conversion circuit of the first module and are output to the cable;
the second beat signals being parallel to one another are converted into second serial signals by the first conversion circuit of the first module and are output to the cable;
the first serial signals received via the cable are restored into the first beat signals being parallel to one another by a third conversion circuit of the second module;
the second serial signals received via the cable are restored into the second beat signals being parallel to one another by the third conversion circuit of the second module; and
the first beat signals restored and the second beat signals restored are output from the third conversion circuit to the detection circuit.

14. The radar signal processing method according to claim 13, wherein
the first beat signals restored and the second beat signals restored are further multiplexed in a time-division manner and output from the third conversion circuit to the detection circuit.

15. The radar signal processing method according to claim 12, wherein
additionally, when the control circuit of the first module receives a stop command from the command circuit of the second module via the cable, an operation of the signal processing circuit of the first module is stopped within one frame by the control circuit of the first module.

16. The radar signal processing method according to claim 13, wherein:
the first module comprises a plurality of the first modules, and the third conversion circuit comprises a plurality of the third conversion circuits;
the plurality of third conversion circuits are provided to correspond respectively to the plurality of first modules;
serial signals output from each of the plurality of first modules are restored by a corresponding one of the plurality of third conversion circuits into first beat signals being parallel to one another and second beat signals being parallel to one another; and
the first beat signals restored and the second beat signals restored are multiplexed in a time-division manner by each of the plurality of third conversion circuits and output to the detection circuit.

17. The radar signal processing method according to claim 14, wherein
additionally, the first serial signals and the second serial signals are multiplexed in a time-division manner and output to the cable by the first conversion circuit of the first module.

18. The radar signal processing method according to claim 17, wherein:
additionally, the first beat signals being parallel to one another and the second beat signals being parallel to one another are compressed by a compression circuit of the first module and output to the first conversion circuit of the first module; and
the first beat signals being parallel to one another and the second beat signals being parallel to one another are expanded by an expansion circuit of the second module, the first and the second beat signals being output from a second conversion circuit of the second module.

19. The radar signal processing method according to claim 18, wherein:
the first module comprises a plurality of the first modules; and
a parallel beat signal from a different first module is input to the compression circuit of the first module.

20. The radar signal processing method according to claim 18, wherein:
the first module comprises a plurality of the first modules; and
serial signals output from a first module different from the first module are converted by the third conversion circuit of the second module into the beat signals being parallel to one another, and are output to the first conversion circuit of the first module.
